(19) United States
(12) Patent Application Publication
(10) Pub. No.: US 2026/0289257 A1
(43) Pub. Date: Sep. 24, 2026

(54) SYSTEM

(71) Applicant: SoftBank Group Corp., Tokyo (JP)

(72) Inventor: Ayaka OMURA, Tokyo (JP)

(73) Assignee: SoftBank Group Corp., Tokyo (JP)

(21) Appl. No.: 19/561,597

(22) Filed: Mar. 10, 2026

(30) Foreign Application Priority Data
Mar. 19, 2025 (JP) 2025-044529

(51) Int. Cl. G06N 3/0475; G06N 3/0455

(52) U.S. Cl. CPC G06N 3/0475; G06N 3/0455

(57) ABSTRACT

A system includes a processor that is configured to collect and analyze past learning data of a user, generate, based on a result of the analysis, a prompt sentence for instructing a generative artificial intelligence model to generate a learning plan, and select and provide appropriate learning materials based on the generated learning plan.

### CROSS-REFERENCE TO RELATED APPLICATION

This application is based on and claims priority under 35 USC 119 from Japanese Patent Application No. 2025-044529 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional learning support systems typically provide static learning plans and generic learning materials that are not sufficiently adapted to an individual learner's historical performance, evolving learning progress, or specific learning environment. As a result, these systems often fail to (i) utilize accumulated past learning data in a structured and dynamic manner, (ii) continuously identify and address user-specific weaknesses with targeted feedback and countermeasures, and (iii) flexibly recommend suitable educational institutions based on the learner's actual conditions and goals. Furthermore, although generative artificial intelligence models have the potential to create highly personalized learning plans and feedback, existing systems do not provide an integrated mechanism for automatically formulating prompts to effectively instruct such models based on analyzed user data. Accordingly, there is a need for a system that can automatically analyze a user's past learning data and learning progress, generate appropriate prompt sentences for a generative artificial intelligence model, and, on that basis, provide optimized learning plans, tailored materials, detailed feedback, and recommendations of optimal educational institutions.

### SUMMARY

To solve the above-described problems, the present invention provides a system comprising a processor, wherein the processor is configured to collect and analyze past learning data of a user, generate, based on a result of the analysis, a prompt sentence for instructing a generative artificial intelligence model to generate a learning plan, and select and provide appropriate learning materials based on the generated learning plan. The processor is further configured to analyze a learning progress of the user and generate a prompt sentence for instructing the generative artificial intelligence model to identify a weakness of the user and to generate feedback and countermeasures, thereby enabling continuous and individualized support that reflects changes in the user's performance over time. In addition, the processor is configured to acquire, from a database, information regarding an educational institution selected by the user, analyze the information based on conditions of the user, such as learning goals, budget, and preferred learning style, and recommend an optimal educational institution. By combining automated prompt generation for a generative artificial intelligence model with analysis of historical and ongoing learning data and with recommendation of educational institutions, the system achieves highly personalized, adaptive, and comprehensive learning support.

The term “system” refers to an arrangement of one or more hardware and/or software components that cooperate to perform the functions described in the present specification and claims, and may include servers, client devices, networks, storage devices, and executable programs.

The term “processor” refers to any hardware device or combination of devices capable of executing instructions, including, but not limited to, a central processing unit (CPU), a graphics processing unit (GPU), a microcontroller, a programmable logic device, or a plurality of such devices operating in coordination.

The term “user” refers to any individual or entity that receives learning support through the system, including, but not limited to, a learner, a student, or a person under education.

The term “past learning data” refers to information related to the user's previous learning activities, including, but not limited to, study time, learning content, test scores, problem-solving history, interaction logs, and any metadata associated with such activities.

The term “learning progress” refers to a change over time in the user's learning state, measured on the basis of metrics such as accumulated study time, completion status of learning tasks, test results, improvement trends, mastery levels, or similar indicators.

The term “analysis” refers to any processing of data to derive information, patterns, or metrics, including, but not limited to, statistical processing, rule-based evaluation, machine learning-based inference, or any combination thereof.

The term “generative artificial intelligence model” refers to an artificial intelligence model that is capable of generating content, such as text, plans, or recommendations, based on input data or instructions, and includes, but is not limited to, large language models and other generative models.

The term “prompt sentence” refers to a text or structured instruction that is supplied as input to a generative artificial intelligence model in order to cause the model to generate a specific output, such as a learning plan, feedback, or countermeasures.

The term “learning plan” refers to a structured plan specifying one or more learning activities for the user, including, but not limited to, target subjects, schedules, durations, difficulty levels, and associated learning materials or tasks.

The term “learning materials” refers to any content used for learning, including, but not limited to, textbooks, articles, videos, audio materials, practice problems, quizzes, interactive exercises, and digital content accessible via a network.

The term “appropriate learning materials” refers to learning materials that are selected based on the generated learning plan and are determined to be suitable for the user's learning goals, level, weaknesses, and learning style.

The term “weakness” refers to an aspect of the user's knowledge, skills, or performance in a particular subject or topic that is determined, based on analysis of learning data or learning progress, to be insufficient or in need of improvement.

The term “feedback” refers to information provided to the user regarding the user's learning performance, weaknesses, or progress, including explanations, evaluations, or guidance.

The term “countermeasures” refers to specific actions, strategies, or recommendations proposed to the user for addressing identified weaknesses, including, but not limited to, targeted practice, review of certain topics, or changes in study methods.

The term “educational institution” refers to an organization that provides education or learning services, including, but not limited to, schools, cram schools, tutoring centers, online education providers, and training facilities.

The term “conditions of the user” refers to constraints or preferences associated with the user, including, but not limited to, learning goals, budget, schedule, location, desired subject areas, and preferred learning style.

The term “database” refers to any structured or unstructured data storage system for storing information, including, but not limited to, relational databases, NoSQL databases, file systems, or distributed storage systems.

The term “information regarding an educational institution” refers to data describing an educational institution, including, but not limited to, name, location, offered courses or subjects, tuition or fees, curriculum details, ratings, reviews, and admission conditions.

The term “recommend” refers to presenting, ranking, or otherwise indicating one or more educational institutions as being suitable or optimal for the user based on the analysis of information and conditions of the user.

The term “optimal educational institution” refers to an educational institution that is determined, based on analysis of information regarding multiple institutions and conditions of the user, to best satisfy the user's requirements or preferences among the considered institutions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

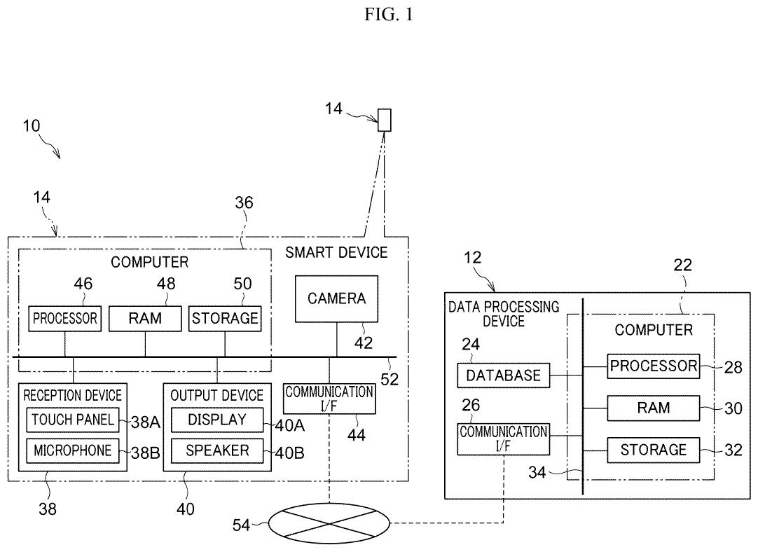

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

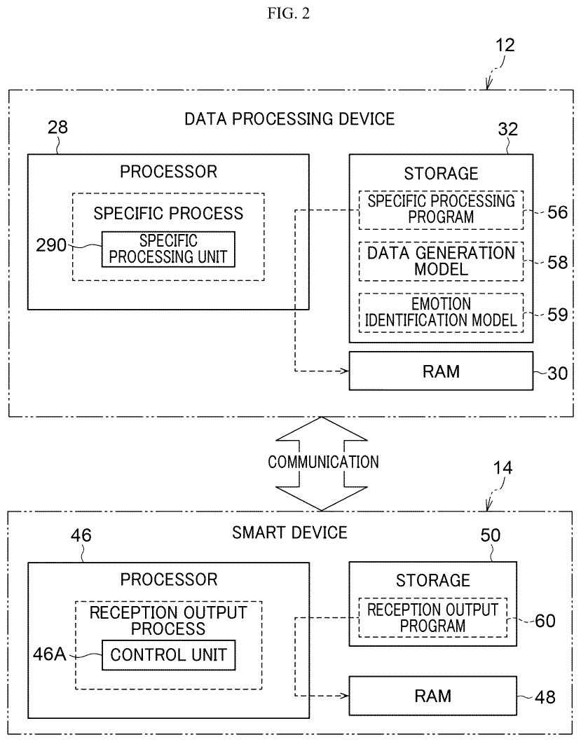

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems rely on static rule-based engines or manually designed recommendation logic to generate learning plans and to select teaching materials. In such systems, user profiles, past learning data, and progress data are typically stored in separate data structures and processed with simple conditional branching. As a result, the systems are limited in their ability to dynamically adapt learning plans to heterogeneous learning styles, abilities, and time constraints. Furthermore, these systems generally treat a generative AI model, if used at all, as a mere black-box text generator, without technically structured control over input and output. Specifically, there is no systematic mechanism for constructing machine-readable prompt sentences that encode normalized user attributes, progress analytics, and external institution information in a way that allows the generative AI model to produce structured, parseable plans suitable for automated downstream processing.

From the viewpoint of computer technology, these limitations cause several technical problems. First, the processing unit must either overfit to rigid rule sets or repeatedly execute ad hoc scripts, which leads to inefficient utilization of computing resources and difficulties in maintaining consistency of generated learning plans. Second, the lack of a defined interface structure for the interaction with the generative AI model prevents the processing unit from reliably controlling output format, length, and content categories, thereby increasing the cost of parsing and often requiring manual intervention or complex heuristic post-processing. Third, progress data and user attributes are not consistently fed back into subsequent generations of learning plans, resulting in repeated full recomputation and redundant data processing rather than incremental, data-driven updates.

Additionally, existing systems that attempt to recommend educational institutions typically implement separate matching logic, which is disconnected from the learning plan generation engine. This separation prevents reuse of the same analysis pipeline and generative processes, and does not provide a unified computational architecture that can transform user attributes, progress analytics, and institution information into both an optimized learning plan and a synchronized institution recommendation. Thus, the overall computer system remains fragmented, leading to increased complexity of data flows, latency in plan updates, and reduced reliability of the generated outputs.

Accordingly, there is a need for an improved computer-implemented system that integrates: (i) normalization and storage of user characteristic and learning objective information, (ii) analytical derivation of learning attributes from raw and historical data, (iii) structured construction of prompt sentences for a generative AI model under explicit constraints, (iv) automated parsing and structuring of generated learning plan text into machine-usable data, (v) iterative feedback loops based on progress analytics, and (vi) integrated handling of educational institution information. Such a system should improve the functioning of the computer as a learning support platform by reducing processing redundancy, increasing controllability and reliability of generative AI outputs, and enabling efficient automatic updates of learning plans and recommendations without manual reconfiguration of rule sets.

The specific processing by the specific processing unit 290 of the data processing device 12 in Example 1 is realized by the following means.

The present invention provides a server comprising a processor and a storage device, the processor being configured to acquire user characteristic information and learning objective information from a terminal, normalize the acquired information into a generic data format, and store the normalized information in the storage device; to analyze, by using a generic data processing program, the user characteristic information and the learning objective information stored in the storage device together with past learning data and learning progress data so as to derive learning attributes including at least a learning style, a learning ability, a learning period, and an available learning time; to generate a prompt sentence in which the learning attributes and analysis results are embedded, the prompt sentence being input to a generative AI model so as to instruct the generative AI model to generate an individualized learning plan; to parse learning plan text obtained from the generative AI model, convert the learning plan text into structured data including learning tasks, learning topics, and teaching material types on a per-day basis or a per-session basis, and select teaching materials corresponding to the user learning style based on the structured data and provide the teaching materials and the learning plan to the terminal; to acquire learning progress data including execution status of the learning tasks, answer results, and learning time from the terminal, store the learning progress data in the storage device, analyze the learning progress data to extract weak fields and delay states in progress, and generate an update prompt sentence including the extracted results and input the update prompt sentence to the generative AI model so as to instruct the generative AI model to update the learning plan and generate feedback; and to acquire candidate educational institution information from an information storage device storing educational institution information, based on user conditions and analysis results, generate a prompt sentence including the candidate educational institution information and the learning attributes of the user, and input the prompt sentence to the generative AI model so as to cause the generative AI model to generate a recommendation of an optimal educational institution and a learning plan adjustment proposal consistent with enrollment conditions of the optimal educational institution, and to provide a result thereof to the terminal. This enables an improvement in the functioning of the computer-based learning support platform by establishing a unified, technically structured interaction loop between normalized user data, analytical processing, constrained prompt sentence construction, generative AI output, and automated parsing, thereby allowing the server to efficiently generate, update, and align individualized learning plans and educational institution recommendations in a machine-controlled manner that reduces redundant computation and enhances reliability and controllability of generative AI outputs.

The term “processor” refers to a hardware computing unit or a combination of hardware computing units that executes machine-readable instructions to perform data acquisition, analysis, generation of prompt sentences, communication with a generative AI model, parsing of generated text, and control of data storage and retrieval.

The term “storage device” refers to a non-transitory computer-readable medium, such as a semiconductor memory, magnetic storage, or optical storage, that stores user information, learning data, analysis results, prompt sentences, learning plans, and educational institution information in a persistent or semi-persistent manner.

The term “terminal” refers to an information processing apparatus operated by a user, such as a client computer, a mobile communication device, or a tablet device, that transmits user information and learning progress data to the server and receives and displays teaching materials, learning plans, and recommendations.

The term “user characteristic information” refers to data representing attributes of a user, including but not limited to personality traits, learning preferences, learning style, current skill level, available study time, and other profile information relevant to learning support.

The term “learning objective information” refers to data indicating a user's learning goals, including but not limited to target subjects, desired proficiency levels, target scores, target periods for learning, and intended examination or certification types.

The term “generic data format” refers to a standardized, machine-readable representation of information, such as a schema-based structured format, that allows user characteristic information and learning objective information to be uniformly processed and stored by the processor and the storage device.

The term “past learning data” refers to data relating to historical learning activities of a user, including records of completed tasks, accessed materials, obtained scores, timestamps, and other historical performance indicators.

The term “learning progress data” refers to data indicating a current or recent state of a user's learning activities, including execution status of learning tasks, answer results, time spent on each task or topic, and completion rates.

The term “generic data processing program” refers to a machine-executable program or a set of machine-executable programs that perform data analysis operations, including normalization, aggregation, statistical computation, classification, and derivation of learning attributes from stored data.

The term “learning attributes” refers to parameters derived from user characteristic information, learning objective information, past learning data, and learning progress data, including at least a learning style, a learning ability level, a learning period, and an available learning time, and optionally including weak areas, strong areas, and topic preferences.

The term “learning style” refers to a classification of a user's preferred mode of learning, including but not limited to visual learning, auditory learning, reading/writing learning, and kinesthetic learning, which influences selection and arrangement of teaching materials.

The term “learning ability” refers to an estimated or measured capability of a user to understand and retain learning content, expressed, for example, as a level such as beginner, intermediate, or advanced, or as a continuous score derived from performance metrics.

The term “learning period” refers to a time interval allocated for achieving a learning objective, including a total number of days, weeks, or months, or specific start and end dates defined for the learning plan.

The term “available learning time” refers to a time quantity that can be allocated by a user for learning within a specified period, such as a number of hours per day or per week.

The term “prompt sentence” refers to an instruction text or a set of instruction texts constructed by the processor, which encodes learning attributes, analysis results, constraint conditions, and optionally external information, and is provided as input to a generative AI model to request generation of a learning plan, feedback, or a recommendation.

The term “generative AI model” refers to a machine learning model capable of generating natural language text or structured text outputs in response to an input prompt sentence, such as a large language model implemented on a computing infrastructure and accessed via an application programming interface.

The term “individualized learning plan” refers to a sequence or structure of learning tasks, schedules, topics, and recommended teaching materials that is tailored to a particular user based on the user's learning attributes and objectives.

The term “learning plan text” refers to textual output data generated by the generative AI model in response to a prompt sentence, the text describing a learning plan in natural language, which is further processed by the processor.

The term “structured data” refers to data that has been converted into a formalized representation, such as records, tables, lists, or key-value pairs, enabling systematic processing by machine-executable programs.

The term “learning task” refers to a unit of learning activity, such as reading a section, watching a lecture, solving a set of problems, or completing a quiz, which can be scheduled and tracked for completion.

The term “learning topic” refers to a thematic category or subject matter area covered in a learning plan, such as a chapter, concept, or skill domain within a broader subject.

The term “teaching material type” refers to a category of content format used for learning, including at least textual material, audiovisual material, interactive content, diagrams, and other instructional resources.

The term “user learning style” refers to the learning style associated with a specific user, as determined from user characteristic information and analysis of user behavior.

The term “weak fields” refers to topics, skills, or subject areas in which a user exhibits relatively low performance, such as low scores or frequent errors, as determined by analysis of learning progress data.

The term “delay states in progress” refers to conditions in which a user's actual learning progress falls behind a planned schedule, as evaluated by comparing completed tasks and expected completion levels.

The term “update prompt sentence” refers to a prompt sentence that includes information regarding weak fields, delay states in progress, and other progress-related analysis results, and is used to request the generative AI model to update an existing learning plan and generate feedback.

The term “feedback” refers to information generated by the generative AI model or by the server that provides guidance, corrections, recommendations, or strategy suggestions to improve a user's learning process.

The term “information storage device” refers to a storage device or database system separate from or included in the storage device, which stores educational institution information and can be accessed by the processor.

The term “educational institution information” refers to data regarding educational entities, such as schools, training centers, or universities, including their programs, entrance conditions, required competencies, and other attributes relevant to user selection.

The term “user conditions” refers to constraints or preferences specified by a user for selecting an educational institution, including desired field of study, location preferences, budget, target level, and time frames.

The term “candidate educational institution information” refers to a subset of educational institution information selected based on user conditions and analysis results, representing potential institutions that may be suitable for a user.

The term “optimal educational institution” refers to at least one educational institution selected or recommended as most suitable for a user based on user conditions, learning attributes, and analysis of educational institution information.

The term “enrollment conditions” refers to requirements or criteria set by an educational institution for admission or participation, including prerequisite knowledge, test scores, portfolios, or language proficiency.

The term “learning plan adjustment proposal” refers to a modification proposal for an existing learning plan that aligns the learning activities, schedule, and target competencies with the enrollment conditions of an educational institution.

The term “output format” refers to a defined structure or layout of text or data to be produced by the generative AI model, including, for example, a list format, a table format, or a sectioned narrative format.

The term “character count constraint” refers to a limitation specified in a prompt sentence regarding the maximum or approximate number of characters or tokens permitted in an output generated by the generative AI model.

The term “ratio of teaching material types” refers to a proportional distribution among different teaching material types, such as a proportion of visual materials to textual materials, to be reflected in the generated learning plan or feedback.

The term “difficulty attributes” refers to metadata assigned to learning tasks indicating relative difficulty levels, such as beginner, intermediate, or advanced, or numeric difficulty scores.

The term “progress evaluation indices” refers to quantitative or qualitative metrics used to evaluate a user's progress in executing learning tasks, such as completion rate, average score, and adherence to schedule.

The term “learning task data” refers to structured data records representing learning tasks, each record including at least task content, associated topic, teaching material type, difficulty attributes, and progress evaluation indices.

The term “display data” refers to data formatted for presentation on a terminal, including layout information and arrangement of learning tasks, which can be rendered in schedule or list formats.

The term “schedule display format” refers to a display style in which learning tasks are arranged and presented along a temporal axis, such as by date or time period, to show when each task should be executed.

The term “list display format” refers to a display style in which learning tasks are presented as items in a list, optionally grouped by topic, day, or priority, without necessarily showing a calendar-based layout.

In one embodiment, a server implements the claimed system using a general-purpose computing platform. The server includes at least one processor, a main memory, a non-transitory storage device, and a network interface. The server uses an operating system such as a general-purpose server operating system, and uses middleware including a web server and an application framework. The server executes application programs written in a high-level programming language such as an interpreted or compiled language. The server also communicates with an external generative AI model through an application programming interface over a communication network.

A terminal operates as a client apparatus and includes a processor, a memory, a display unit, and an input unit such as a touchscreen, keyboard, or pointing device. The terminal executes a web browser or a native application framework to present graphical user interfaces. The terminal exchanges data with the server via a secure communication protocol. A user operates the terminal to input information and to view learning plans and related content.

The server stores user characteristic information, learning objective information, past learning data, learning progress data, and educational institution information in one or more storage devices. In one embodiment, the server uses a relational database management system to store the data in tables such as a user table, a profile table, a learning history table, a progress log table, a learning plan table, and an educational institution table. The server uses a data access library or an object-relational mapping library to read and write records in the database. The server uses a data analysis library to perform normalization, aggregation, and statistical computation on the stored data.

The server normalizes user characteristic information and learning objective information into a generic data format. For example, the server converts free-text descriptions such as “I like to learn visually and I want to pass a university entrance exam in 3 months” into canonical fields: learning_style=“visual”, goal_type=“university_exam”, learning_period_days=90, and available_learning_time_per_day_hours as a numeric value. The server stores such normalized fields as column values in the database. The server thereby reduces ambiguity in the subsequent processing and improves consistency of data across different users.

The server derives learning attributes from normalized user characteristic information, learning objective information, past learning data, and learning progress data. The server uses numerical features such as average quiz scores, completion rates for previous tasks, time spent per topic, and variability of scores. The server also uses categorical features such as subject category, difficulty label, and content type. The server applies classification or regression algorithms, for example a gradient-boosted decision tree model or a shallow neural network, to estimate a learning ability level and to categorize a learning style when explicit information is missing or incomplete. In one variant, the server uses a small feedforward neural network with an input layer receiving feature vectors, one or more hidden layers with rectified linear units, and an output layer producing a probability distribution over ability levels. The server trains this network in advance using supervised learning with historical labeled data, minimizing a cross-entropy loss by a stochastic gradient descent method. The server stores trained parameters in the storage device and loads them into memory for inference.

The server constructs a prompt sentence for a generative AI model based on the derived learning attributes and analysis results. The server uses a deterministic template-based generator to assemble the prompt sentence. The server defines multiple template segments for profile description, objectives, constraints, and output format. The server interpolates specific attribute values into the template segments using string formatting operations. The server also inserts constraint instructions into the prompt sentence, such as restrictions on maximum length, structure of the output, and ratio of teaching material types. The server thereby controls the behavior of the generative AI model in a consistent and machine-parseable manner.

For example, the server can generate a prompt sentence such as:

“You are an expert study planner. The user is an intermediate learner in mathematics.

The user prefers visual learning and has 2 hours per day for 60 days. Past quiz scores show an average of 85% in algebra and 60% in geometry, with geometry identified as a weak area. Create a 60-day learning plan that focuses extra practice on geometry while maintaining algebra skills. Provide a day-by-day schedule with specific tasks, recommended teaching material types (text explanation, diagram, video, or interactive exercise), and estimated time per task. Use headings ‘Day 1’, ‘Day 2’, and so on, and limit the response to approximately 1500 words.”

The server communicates with a generative AI model implemented as a large-scale neural network, for example a transformer-based language model. The generative AI model includes an input embedding layer, a positional encoding mechanism, multiple self-attention layers, feedforward layers, and an output linear layer producing token probabilities. The generative AI model is pre-trained on a large corpus and optionally fine-tuned for instructional planning tasks using supervised learning or reinforcement learning with human feedback. During inference, the generative AI model receives the prompt sentence as a sequence of tokens, computes attention-based context representations, and outputs a sequence of tokens representing the learning plan text.

The server sends the constructed prompt sentence to the generative AI model through an API client library. The server specifies model parameters such as temperature, maximum tokens, and top-k or top-p sampling thresholds to control diversity and determinism of the output. The server receives an output text from the generative AI model in a structured narrative form. The server logs the prompt sentence and the response together with timestamps and an identifier of the user, which allows reproducibility and later audit of modifications.

The server parses the learning plan text generated by the generative AI model and converts it into structured data. The server does not rely solely on generic regular expressions; instead, the server uses a dedicated parsing module that expects a constrained output structure as instructed in the prompt sentence. The server recognizes day headings (for example, “Day 1:”), topic bullets, and task descriptions using pattern-based segmentation. The server maps each task description to a record including a day index, a topic label, a textual description, an estimated duration, and a teaching material type. The server stores the resulting structured data in learning plan tables in the database. The server also assigns difficulty attributes to tasks by analyzing keywords such as “introduction”, “advanced”, “challenging”, and by using a trained classifier that receives term-frequency vectors or sentence embeddings and outputs a difficulty label. This combination of controlled prompt structure and dedicated parsing reduces parsing errors and post-processing overhead, thereby improving computational efficiency and the reliability of the resulting task schedule.

The server further processes teaching material types. When the generative AI model outputs free-text descriptions like “watch a video explaining Pythagorean theorem,” the server uses a content-type classifier to map this description to one of the teaching material types stored in the database. The classifier can be a simple rule-based system or a neural text classifier. The server then selects or retrieves actual material identifiers from a material catalog stored in the storage device, linking each task to one or more concrete resources such as a video entry, a diagram collection, or a text article. The server thereby transforms high-level textual plans into executable, machine-manageable tasks.

The terminal receives structured learning plan data from the server and renders it on the display. The terminal uses client-side scripts to generate a schedule view or a list view. The terminal displays tasks for each day, indicates difficulty levels, and distinguishes teaching material types using icons or color codes. The user interacts with the terminal to mark tasks as completed, to enter quiz scores, and to report actual time spent. The terminal collects this progress data and transmits it to the server.

The server stores learning progress data sent from the terminal. The server continuously updates aggregate statistics such as completion rate, average score per topic, and accumulated learning time. The server compares these statistics with planned values derived from the structured learning plan. When the server detects significant deviation, such as completion rate below a predetermined threshold or scores consistently below a target level, the server identifies weak fields and delay states in progress. The server encodes such analysis results as structured variables and inserts them into an update prompt sentence.

An example of an update prompt sentence is:

“The user has followed a 30-day mathematics learning plan for 10 days. The original plan assumes 1.5 hours per day with equal focus on algebra and geometry. Progress logs show that the user has completed 80% of planned algebra tasks with an average score of 85%, but has completed only 30% of planned geometry tasks with an average score of 60%. The user is a visual learner. Update the remaining 20 days of the plan to allocate more time to geometry, introduce additional visual explanations and diagrams for geometry topics, and adjust daily time so that the total daily study time does not exceed 1.5 hours. Provide specific daily tasks and indicate teaching material types for each task.”

The server sends this update prompt sentence to the generative AI model and receives a revised textual plan and feedback. The server parses and merges the revised plan into the existing structured data, updating tasks for remaining days while preserving completed history. This incremental update mechanism avoids full regeneration of the entire schedule and reduces computational load and network bandwidth usage. The server also stores feedback messages, which may include strategy suggestions and motivational advice, and transmits them to the terminal.

The server additionally uses educational institution information stored in an information storage device. The server stores institution records including required scores, prerequisite topics, duration of study programs, and other criteria. The server filters these records based on user conditions such as desired field, preferred location, budget, and time frame. The server produces candidate educational institution information and incorporates it into a prompt sentence to obtain a recommendation and an adjusted learning plan aligned with enrollment conditions.

For example, the server can generate a prompt sentence such as:

“The user is a high-school student who wants to enter a higher-education institution with a strong program in computer science. The user currently has an intermediate level in mathematics and aims to reach an advanced level in 6 months. The following institutions are candidates: Institution A requires an entrance exam score of 80 in mathematics and emphasizes calculus and discrete mathematics; Institution B requires a portfolio including programming projects and a mathematics score of 70; Institution C requires standardized test scores with high performance in algebra and geometry. Based on the user's profile and progress, recommend one or more optimal institutions among A, B, and C, explain the reasons, and propose adjustments to the 6-month learning plan to meet the enrollment conditions of the recommended institutions. Provide a structured recommendation with sections ‘Recommended Institutions’ and ‘Plan Adjustments’.”

The server uses structured templates and machine parsing to convert the generative AI model's recommendation into structured records associating institutions with required competencies and recommended study focus. The server updates learning tasks to emphasize competencies most relevant to the selected institutions, such as advanced algebra or programming fundamentals, while maintaining schedule constraints.

From a technical standpoint, the described architecture provides improvements in computer technology beyond mere automation of human planning. First, the server implements a constrained prompt generation and parsing loop that transforms free-form natural language generation into a reliably machine-consumable planning pipeline. Because the server enforces template-based prompt sentences and constrained output formats, the server can parse and structure the output with a lower error rate and reduced computational complexity, which shortens processing time and reduces CPU usage for post-processing.

Second, the server uses normalized data structures and analytical derivation of learning attributes to avoid redundant recomputation. When the server updates a learning plan based on new progress data, the server reuses existing structured task records and modifies only future portions of the plan. This incremental update approach reduces database write operations and network traffic, thereby decreasing latency and improving scalability when multiple users are processed concurrently.

Third, the server combines a discriminative model (for example, a neural classifier for difficulty and ability estimation) with a generative AI model under explicit constraints. The server does not simply replace human decision-making with a black-box model; instead, the server orchestrates multiple models with different roles using well-defined intermediate data structures. This modular design allows optimization of each component—classification, attribute derivation, generative planning, and parsing—leading to higher accuracy in matching plan difficulty to user ability and improved stability of plan quality across a wide range of users.

Fourth, by integrating educational institution information into the same generative-planning loop, the server provides a coordinated adjustment of learning tasks with external constraints. The server thereby avoids the conventional situation where institution recommendation logic and learning plan logic are separated and manually reconciled. The unified architecture reduces inconsistency, prevents contradictory guidance, and ensures that plan generation respects both user attributes and institution requirements in a technically coherent manner.

The generative AI model itself can be further specified in alternative embodiments. In one embodiment, the generative AI model is a transformer network with L layers, each layer including multi-head self-attention with H heads and position-wise feedforward networks. The model uses byte-pair encoding or similar tokenization. The model is trained to minimize a language modeling loss using a large unlabeled corpus and then fine-tuned on a dataset of study plans and instructional texts. The fine-tuning may use a masked language modeling objective, sequence-to-sequence objectives, or instruction-following objectives. The model parameters are stored in a model storage and loaded into a model serving cluster. The server calls the model via network requests that include the prompt sentence and hyperparameters. The model returns token sequences; the server decodes them to text.

In another embodiment, the server uses a smaller in-house generative model for privacy-sensitive environments. The server deploys the generative AI model as a containerized microservice on the same hardware platform. The server uses shared memory or inter-process communication to reduce latency when transmitting prompt sentences and receiving responses. This configuration reduces communication overhead and improves responsiveness compared with relying solely on a remote cloud model.

The terminal implementations can also vary. In one embodiment, the terminal uses a web browser to run client-side scripts written in a scripting language. In another embodiment, the terminal uses a native mobile application. The terminal may cache parts of the learning plan locally to enable offline viewing. When the terminal reconnects, the terminal transmits offline progress logs to the server, which sequentially incorporates them into progress analysis. This design reduces repeated downloads of the same plan data, lowers network usage, and maintains robust operation even with intermittent connectivity.

In all embodiments, the server, the terminal, and the user cooperate to implement the claimed system. The server performs structured acquisition, normalization, analysis, constrained prompt sentence construction, generative AI interfacing, and deterministic parsing. The terminal presents interactive views and gathers precise progress measurements. The user provides initial goals and interacts with the plan. The overall configuration improves technical performance in terms of computational efficiency, data consistency, controllability of generative outputs, and the ability of the computer system to maintain coherent, individualized learning plans tightly aligned with both user behavior and external educational requirements.

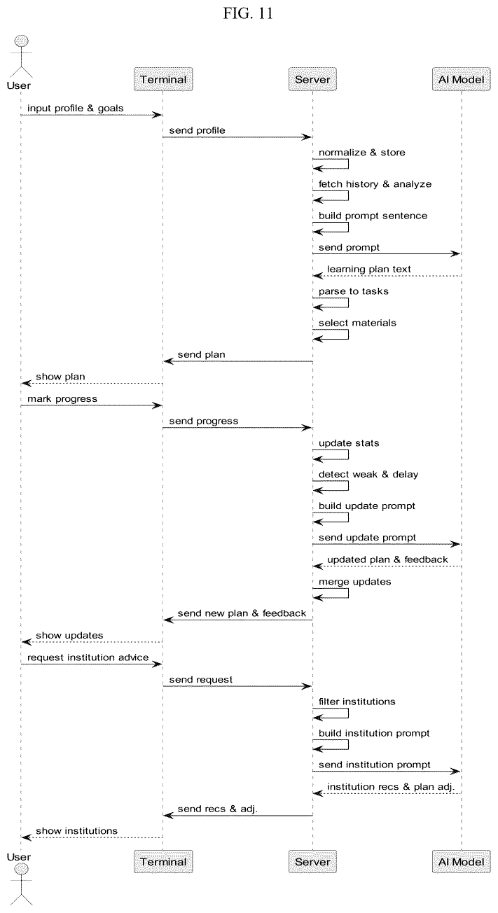

The following describes the processing flow using FIG. 11.

### Step 1:

The terminal displays an input interface and collects initial user information.

The terminal presents input fields for user characteristic information and learning objective information, including learning style, preferred subject, current level, available learning time, and target period. The user operates the terminal and enters text such as “visual learner,” “target: university entrance exam,” and “1.5 hours per day for 90 days.” As input, the terminal receives raw text strings and numeric values from the user through the display and input unit. The terminal performs client-side validation, such as checking that required fields are not empty and that numeric values are within a valid range. The terminal then converts the validated data into a structured internal representation (for example, key-value pairs in memory) and prepares this as output to be sent to the server via a secure communication channel.

### Step 2:

The server receives the initial data and normalizes it into a generic data format.

The server accepts, as input, the structured data transmitted from the terminal, including raw descriptions of learning style and goals. The server parses the incoming message, extracts each field, and maps free-text expressions to canonical categories. For example, the server converts “I like images and videos” into learning_style=“visual” and converts “pass a university exam in 3 months” into goal_type=“university_exam” and learning_period_days=90. The server performs data transformations such as trimming whitespace, lowercasing, and mapping synonyms using a predefined dictionary. Based on these operations, the server produces normalized attribute values and stores them as rows and columns in a database. The server outputs confirmation data, including a user identifier and normalized fields, for subsequent processing stages.

### Step 3:

The server retrieves past learning data and aggregates it with the normalized profile.

The server uses the user identifier as input to query the storage device for past learning data and any existing learning progress data. The server loads records of completed tasks, quiz scores, and time logs. The server then aggregates these records, computing statistics such as average score per subject, completion rate, and total time studied. For example, the server calculates the mean quiz score using summation and division operations and computes completion rate as a ratio of completed tasks to planned tasks. The input for this step consists of normalized profile data and historical records; the output is a set of aggregated metrics and feature vectors that represent the user's learning history and current status.

### Step 4:

The server derives learning attributes using analytical and model-based computation.

The server receives, as input, the aggregated metrics and normalized profile data produced in Step 3. The server constructs a feature vector including numeric values (such as average score, variance of scores, time per topic) and categorical encodings (such as subject category and normalized learning style). The server feeds this feature vector into a trained classifier or regression model implemented on the server, for example a small neural network or decision tree model, to estimate a learning ability level (e.g., beginner, intermediate, advanced). The server also determines an effective learning period and available learning time per day based on the user input and any constraints stored in system configuration. The server performs mathematical operations such as matrix multiplication (in the case of a neural network), activation function evaluation, and thresholding. The output of this step is a set of learning attributes, including learning style, learning ability level, learning period, and available learning time, which the server stores and passes to the prompt construction module.

### Step 5:

The server constructs an initial prompt sentence for a generative AI model.

The server takes the derived learning attributes and analysis results from Step 4 as input. The server selects a prompt template corresponding to the subject and goal type, and then inserts concrete attribute values into predefined placeholders. For example, the server builds text segments such as “The user is an intermediate learner in mathematics,” and “The user prefers visual learning and has 2 hours per day for 60 days.” The server also appends constraint instructions specifying output format (e.g., “Provide a day-by-day schedule with headings ‘Day 1’, ‘Day 2’, . . . ”) and length (e.g., “Limit the response to approximately 1500 words”). The server concatenates all segments into one continuous prompt sentence. The input to this step is a structured set of attributes; the output is a single prompt sentence text string that is ready to be sent to the generative AI model.

### Step 6:

The server sends the prompt sentence to the generative AI model and obtains a learning plan text.

The server receives, as input, the prompt sentence produced in Step 5. The server uses an API client to encode the prompt sentence into a request message and transmits it to a generative AI model hosted on a remote or local model-serving system. The generative AI model processes the prompt sentence using a transformer-based neural network, performing internal operations such as token embedding, self-attention, and feedforward transformations to predict the next tokens in the output sequence. The server waits for the response and receives a generated text that describes an individualized learning plan. The input for this step is the prompt sentence; the output is the learning plan text produced by the generative AI model, which the server stores and passes to the parsing module.

### Step 7:

The server parses the learning plan text into structured learning task data.

The server takes, as input, the learning plan text returned by the generative AI model. The server applies a parsing algorithm that searches for structural markers specified in the prompt, such as “Day 1:”, “Day 2:”, and bullet lists of tasks. The server splits the text into segments corresponding to each day or session, then further splits each segment into individual task descriptions. For each task description, the server extracts fields such as topic name, estimated time, and teaching material type, using pattern recognition and rule-based mapping (e.g., mapping phrases like “watch a video” to a “video” material type). The server also assigns an internal identifier to each task and associates difficulty attributes based on keyword analysis or a difficulty classifier. The output of this step is a structured task list, for example a set of records each containing day index, topic label, task description, material type, and difficulty level, which the server stores in the database.

### Step 8:

The server selects concrete teaching materials and prepares data for delivery to the terminal.

The server uses the structured task list from Step 7 and the user learning style as input. The server queries a material catalog stored in the database to find concrete resources that match each teaching material type, topic, and difficulty. For example, when a task indicates “visual explanation of Pythagorean theorem,” the server selects a diagram resource and a video resource tagged with that topic and visual style. The server performs filtering and ranking based on metadata fields such as relevance score, length, and language. The server then attaches selected material identifiers and URLs to each task record. The output of this step is an enriched learning plan dataset that includes both abstract tasks and concrete materials, which the server converts into a response format suitable for the terminal.

### Step 9:

The terminal receives the structured learning plan and renders it for the user.

The terminal takes, as input, the enriched learning plan dataset transmitted from the server, which includes tasks organized by day, topics, difficulty, and associated materials. The terminal parses the received data and generates user interface elements such as a calendar view or a list view. The terminal groups tasks by date, displays task descriptions, and shows icons or labels indicating material types (e.g., text, diagram, video). The terminal also embeds links or buttons that allow the user to open each material. The output of this step is a visual representation of the learning plan on the display, enabling the user to understand what to study and when.

### Step 10:

The user executes the learning tasks and records progress through the terminal.

The user reads the displayed learning plan on the terminal and performs tasks such as watching a video, reading an article, or solving example problems. After completing each task, the user operates the terminal to mark the task as completed and to enter information such as quiz scores and time spent. The terminal receives, as input, the user's interactions including button presses and numeric score entries. The terminal updates local state to reflect completion status and packages progress data into a structured form. The output of this step at the terminal side is a progress data message prepared for transmission to the server.

### Step 11:

The terminal transmits learning progress data to the server.

The terminal sends, as input to the server, the progress data message containing identifiers of completed tasks, scores, and actual time spent. The terminal uses a secure communication protocol to transmit this data. The output of this step is an acknowledgment from the server and, optionally, a short status update indicating that the progress has been recorded. The terminal may also clear temporary local buffers once successful transmission is confirmed.

### Step 12:

The server stores and analyzes learning progress data to identify weak fields and delay states.

The server accepts, as input, the progress data message from the terminal. The server inserts new records into a progress log table and updates summary fields such as total completed tasks and average score per topic. The server then compares actual completion percentages and scores with planned values in the structured learning plan. For example, the server computes the difference between expected and actual completion by dividing completed tasks by planned tasks for each day or topic, and flags topics where the ratio falls below a threshold. The server also detects delay states by comparing actual elapsed time with scheduled tasks. The output of this step is an analysis result that includes identified weak fields, delay states, and updated performance metrics.

### Step 13:

The server constructs an update prompt sentence reflecting the latest progress analysis.

The server uses the analysis result from Step 12 and the existing learning attributes as input. The server builds a new prompt sentence that describes the original plan, the user's actual progress, identified weaknesses, and specific adjustment requests. The server follows a template similar to: “The user has completed X % of algebra tasks and Y % of geometry tasks with corresponding average scores. Geometry is a weak area. Adjust the remaining days to increase geometry practice while keeping daily study time within the original limit.” The server again appends constraints on output format and length. The resulting text is an update prompt sentence that explicitly encodes the necessary adjustments. The output of this step is a new prompt sentence ready to be sent to the generative AI model.

### Step 14:

The server sends the update prompt sentence to the generative AI model and receives an updated plan and feedback.

The server inputs the update prompt sentence into the generative AI model via the API, specifying model parameters such as temperature and maximum output length. The generative AI model processes this input and generates an updated learning plan text and feedback, which may include additional exercises, reallocated time, and study strategies. The server receives this output as text. The input for this step is the update prompt sentence; the output is the revised plan text and feedback text, which the server logs and forwards for parsing.

### Step 15:

The server parses and merges the updated plan into the existing structured learning plan.

The server takes the updated learning plan text from Step 14 and the current structured plan as input. The server parses the updated text in the same manner as in Step 7, identifying days and tasks. The server then aligns the updated tasks with existing future days, replacing or modifying tasks only for uncompleted days while leaving completed history intact. The server updates database records for future tasks, changing topics, material types, or estimated times according to the revised plan. The output of this step is an updated structured learning plan that reflects both historical progress and newly generated adjustments.

### Step 16:

The server generates and delivers feedback messages to the terminal.

The server extracts feedback sections from the generative AI model's output text, which may include explanations like “focus more on geometry problems that involve proofs” or “use more visual aids for complex formulas.” The server formats these feedback messages into short, segmented text units and associates them with the user's plan or specific topics. The server then transmits these feedback messages along with the updated plan structure to the terminal. The input is the parsed feedback text; the output is a response payload containing feedback and any updated tasks.

### Step 17:

The terminal presents updated plans and feedback to the user.

The terminal receives, as input, the response payload from the server containing the updated structured plan and feedback messages. The terminal updates the displayed schedule by modifying tasks in upcoming days, changing labels or material icons as needed. The terminal also presents feedback messages in a dedicated area, such as a notification panel or a recommendation section. The output of this step is an updated visual representation of the learning plan and clear guidance messages visible to the user on the display.

### Step 18:

The server processes educational institution information and integrates recommendations into the plan.

The server may receive, as input, a request from the terminal indicating that the user wishes to obtain educational institution recommendations. The server retrieves user conditions (desired field, time frame, target level) and current learning attributes, and queries an institution database to filter candidates. The server selects candidate institutions that match basic conditions and then constructs a prompt sentence describing these candidates and the user's status. The server submits this prompt sentence to the generative AI model, receives a recommendation text, and parses it to identify recommended institutions and suggested adjustments to meet enrollment conditions. The output is a set of recommended institutions and corresponding plan adjustments, which the server incorporates into the structured learning plan and sends to the terminal for display to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented learning support systems, a processor typically applies fixed rule-based logic or static recommendation algorithms to generate learning plans. Such systems often treat learner profiles and learning progress data as simple lookup parameters, without deeply integrating these data into the control flow of a generative model. As a result, the generated learning plans are coarse-grained, are not continuously adapted to the learner's evolving state, and impose significant manual configuration overhead on system operators.

Moreover, when conventional systems attempt to use generative AI models, they generally pass only shallow parameters, such as subject and difficulty, to the model. The construction of input instructions for the model (prompt sentences) is usually hard-coded or template-based, and does not dynamically reflect structured learner profile information, fine-grained progress signals, or detected weaknesses. This leads to unstable output quality, difficulty in debugging or tracing the model behavior, and inefficient use of computing resources because repeated model calls may fail to converge toward improved plans.

From a system architecture standpoint, existing solutions inadequately structure the data pipeline between terminals, servers, and generative AI models. Learner characteristic information, learning ability information, past learning data, learning progress information, and feedback information are not consistently normalized into a unified profile representation that can be programmatically transformed into prompt sentences. Consequently, the processor cannot efficiently orchestrate iterative cycles of prompt generation, model inference, and plan refinement, and cannot effectively convert free-form model outputs into structured, machine-usable learning plan data.

In addition, conventional systems provide limited computer-implemented support for selecting educational institutions based on an integrated view of learner profiles and dynamically updated learning plans. Institution recommendation is often handled by separate, static matching engines that are not tightly coupled with plan generation logic or generative AI capabilities, thereby preventing the system from leveraging the same prompt engineering and model inference pipeline to generate institution recommendations and explanations tailored to the learner's evolving state.

Accordingly, there is a need for an improved computer-implemented system and processing method in which a processor: (i) acquires and maintains a unified learner profile; (ii) dynamically generates prompt sentences in natural language that accurately encode both static characteristics and dynamic progress; (iii) controls a generative AI model to generate personalized learning plan information and recommendation information; and (iv) converts the model output into structured data usable by downstream components. Such a system should improve the efficiency, stability, and traceability of the overall learning support pipeline, reduce manual configuration, and enhance the adaptability and personalization of the generated plans and institution recommendations, thereby improving the operation of the underlying computer technology itself.

The specific processing by the specific processing unit 290 of the data processing device 12 in Application Example 1 is realized by the following means.

The present invention provides a server comprising a processor and a memory storing instructions that, when executed by the processor, cause the processor to acquire learner characteristic information and learning ability information from a terminal as input data, store the learner characteristic information and the learning ability information as learner profile information in an associated storage resource, generate, based on the learner profile information and past learning data of a learner, a prompt sentence expressed in natural language as input data for a generative AI model, execute numerical computation processing by providing the prompt sentence to the generative AI model to obtain personalized learning plan information, analyze the learning plan information output from the generative AI model and convert the learning plan information into structured data including schedule information, learning material information, and learning method information, select, based on the learning material information and the learner profile information, learning materials to be presented to the learner, transmit the structured data and the selected learning materials to the terminal for display, acquire learning progress information and feedback information from the terminal, update the learner profile information using the learning progress information and the feedback information to generate updated learner profile information, regenerate, based on the updated learner profile information, an updated prompt sentence for the generative AI model, and repeatedly execute regeneration processing of updated learning plan information by the generative AI model using the updated prompt sentence; and further cause the processor, in some embodiments, to acquire institution information from a storage resource, incorporate condition information regarding institution types, educational content, difficulty levels, and admission requirements into the prompt sentence based on the learner profile information and the learning progress information, and control the generative AI model to generate recommendation information including institution candidates and selection reasons consistent with the learning plan information and the condition information. This enables the computer system to implement an iterative, profile-driven prompt generation and model-inference pipeline that dynamically adapts learning plans and institution recommendations to the learner's evolving state, improves the utilization and controllability of the generative AI model, produces machine-usable structured plan data from free-form model outputs, and enhances the overall efficiency, scalability, and technical performance of the learning support infrastructure.

The term “learner” refers to a human user who receives a learning plan, learning materials, or recommendation information generated by the system and who interacts with the system via a terminal.

The term “terminal” refers to an information processing apparatus, such as a client computing device, configured to transmit learner-related information to the server and to present learning plan information, learning materials, and recommendation information to the learner.

The term “server” refers to an information processing apparatus, or a group of interconnected information processing apparatuses, comprising at least one processor and at least one memory, and configured to execute the processing for acquiring, storing, generating, and transmitting data as described in the claims.

The term “processor” refers to a hardware computing element, such as a central processing unit or a graphics processing unit, or a combination thereof, configured to execute instructions to perform arithmetic and logical operations in accordance with the present invention.

The term “memory” refers to a non-transitory computer-readable storage medium, such as a semiconductor memory, magnetic storage, or optical storage, configured to store instructions and data for execution and use by the processor.

The term “storage resource” refers to any hardware-based data storage component, including but not limited to databases and file systems, configured to store learner profile information, learning progress information, feedback information, and institution information.

The term “learner characteristic information” refers to data indicating static or semi-static attributes of the learner, such as preferences, learning style, personality traits, or other properties relevant to personalization of learning.

The term “learning ability information” refers to data indicating a level, skill, or capability of the learner with respect to one or more subjects or competencies.

The term “learner profile information” refers to information that includes at least learner characteristic information and learning ability information, and may further include past learning data, learning progress information, and feedback information, consolidated into a unified representation associated with a particular learner.

The term “past learning data” refers to historical data related to learning activities of the learner, including but not limited to previously completed tasks, scores, time spent, and prior learning plans.

The term “learning progress information” refers to data indicating the current or past state of advancement of the learner with respect to a learning plan, such as completion status of tasks, pace, or performance indicators.

The term “feedback information” refers to data provided directly or indirectly by the learner, such as ratings of difficulty, subjective evaluations, comments, or other responses indicating the learner's experience with the learning activities.

The term “updated learner profile information” refers to learner profile information that has been modified based on learning progress information and feedback information so as to reflect an evolved state of the learner.

The term “prompt sentence” refers to a sequence of natural language text generated by the processor and supplied as input to a generative AI model, the sequence encoding at least part of the learner profile information, learning objectives, conditions, or constraints for generating learning plan information or recommendation information.

The term “generative AI model” refers to a computer-implemented model that receives at least one prompt sentence as input and produces generated content, such as learning plan information or recommendation information, by performing machine learning-based numerical computations.

The term “numerical computation processing” refers to operations executed by the processor or by an accelerator under control of the processor, such as vector and matrix operations, non-linear transformations, and probabilistic inference, for evaluating the generative AI model using a prompt sentence.

The term “learning plan information” refers to information generated by the generative AI model that defines or describes a course of learning for the learner, including at least one of schedule-related data, learning material-related data, or learning method-related data.

The term “schedule information” refers to data specifying temporal aspects of a learning plan, including but not limited to time periods, order of topics, and planned tasks for given intervals.

The term “learning material information” refers to data describing learning materials recommended or referenced by a learning plan, including identifiers, types, or attributes of such materials.

The term “learning method information” refers to data describing strategies, techniques, or approaches to be used by the learner when engaging with the learning materials, and may include instructions aligned with a particular learning style.

The term “structured data” refers to data organized according to a predefined schema or format, such as a set of fields or key-value pairs, which can be programmatically processed by the server and the terminal.

The term “learning materials” refers to content items used to support learning, including but not limited to text, images, audio, video, interactive applications, or problem sets.

The term “weakness areas” refers to one or more topics, skills, or problem types identified, based on learning progress information or feedback information, as relatively deficient for the learner.

The term “achievement levels” refers to indicators of the learner's proficiency or performance in one or more topics or skills, derived from learning progress information, past learning data, or feedback information.

The term “reinforcement learning tasks” refers to tasks or activities that are designed, according to the generated learning plan information, to strengthen the learner's abilities in one or more weakness areas.

The term “institution information” refers to data related to educational institutions, including at least information about institution types, educational content, difficulty levels, and admission requirements.

The term “institution types” refers to classifications of educational institutions, such as general categories of schools, training programs, or other educational entities.

The term “educational content” refers to fields of study, courses, curricula, or subject areas offered by educational institutions.

The term “difficulty levels” refers to indicators of the relative complexity or advancement of educational content or programs.

The term “admission requirements” refers to conditions or criteria that must be satisfied for entry into an educational program or institution.

The term “condition information” refers to constraints, preferences, or selection criteria regarding institution types, educational content, difficulty levels, or admission requirements, derived from the learner profile information and the learning progress information.

The term “recommendation information” refers to information generated by the generative AI model that includes at least institution candidates and corresponding reasons for selection, based on the learning plan information and the condition information.

The term “institution candidates” refers to educational institutions or programs that are selected or proposed as suitable options for the learner according to the recommendation information.

The term “selection reasons” refers to explanations, criteria, or justifications included in the recommendation information that indicate why particular institution candidates are considered suitable for the learner.

The term “present” refers to causing data, such as learning plan information, learning materials, or recommendation information, to be output to and displayed on a terminal for perception by the learner.

The term “transmit” refers to sending data from the server to the terminal, or from the terminal to the server, via a communication network according to a communication protocol.

In one embodiment, a server implements the claimed system using one or more general-purpose processors, one or more graphics processing units, a main memory, a non-transitory storage device, and a network interface. The server executes an operating system and middleware, and executes application software including a web application framework, an application server, and a machine learning runtime. The server communicates with one or more terminals over a communication network, and each terminal presents information to a user and acquires input from the user.

### A. Overall Configuration

The server includes a profile management module, a prompt generation module, a generative AI inference module, a plan structuring module, a material selection module, a progress analysis module, and a recommendation module. Each module is implemented as a software component executed by the processor. The server stores learner profile information, learning progress information, feedback information, and institution information in a structured database. The database is implemented as a relational database management system or a key-value store. The server uses a machine learning framework, such as a tensor-based computation library, to implement a generative AI model.

The terminal includes a processor, a memory, a display, and input devices such as a touchscreen. The terminal executes a client application that is implemented, for example, using a cross-platform application framework. The client application communicates with the server using a network protocol such as HTTPS.

The user operates the terminal to input learner characteristic information, learning ability information, learning objectives, and feedback. The user views learning plan information, learning materials, and recommendation information that the terminal receives from the server.

### B. Learner Profile Management

The server acquires learner characteristic information and learning ability information from the terminal. The server normalizes this information into a learner profile data structure. In one embodiment, the server represents the learner profile as a record with fields for learning style, personality traits, preferred content formats, declared proficiency levels per subject, and long-term and short-term goals. The server stores the learner profile in the storage device as part of a persistent data model, associating it with a unique learner identifier.

The server further associates past learning data with the learner profile. The past learning data includes, for example, timestamps of completed tasks, scores on assessments, error types in responses, and time spent on each activity. The server aggregates these data points into derived features, such as average completion time per topic, distribution of error categories, and retention indicators inferred from repeated attempts. The server stores these derived features together with the learner profile.

The server thereby maintains an updated learner profile that combines static attributes and dynamic performance measures in a unified data structure. This data structure is used as an input to the prompt generation module and the generative AI inference module.

### C. Prompt Sentence Generation and Data Representation

The server generates a prompt sentence in natural language based on the learner profile information and at least a subset of the past learning data and learning progress information. The server does not perform simple template substitution only; instead, the server constructs the prompt sentence via a rule-based and feature-aware assembly process. The server maps internal profile fields and progress metrics to textual descriptors, for example, mapping a numerical proficiency score to a qualitative description such as “beginner” or “intermediate,” and mapping error distributions to phrases such as “still struggles with algebraic word problems involving multi-step reasoning.”

In one concrete example, when the learner is identified as a visual learner studying mathematics, and the past learning data indicates difficulty in word problems, the server generates a prompt sentence such as:

“The user is a visual learner studying high-school level mathematics to prepare for a university entrance examination in one year. The user has completed the first unit on basic algebra but still struggles with multi-step algebraic word problems and requires more visual explanations. Please generate an optimal learning plan including: (1) a week-by-week study schedule, (2) visual learning materials such as diagrams, animations, and interactive tools, and (3) step-by-step practice activities focusing on algebraic word problems.”

In another example, the server generates a prompt sentence for language learning:

“The user is an auditory learner who wants to improve English listening and speaking skills for business communication. The user has difficulty understanding fast speech and maintaining fluency in spontaneous conversation. Please generate a three-month learning plan including daily listening activities, graded audio materials from slow to fast speed, and spoken interaction exercises such as shadowing and role-play dialogues.”

The server encodes internal metrics and constraints directly into these prompt sentences. This encoding is not a trivial user instruction but a structured representation of machine-derived features, such as “difficulty rating 4 out of 5,” “time spent 300 minutes,” or “behind schedule by one week,” which the server converts into text in a manner consistent across learners. By standardizing these mappings, the server improves the reproducibility and interpretability of generative AI model behavior.

### D. Generative AI Model Architecture and Training

The server implements the generative AI model as a neural network architecture, for example, a sequence-to-sequence model with an encoder-decoder structure or a transformer-based language model. The model includes an embedding layer that maps discrete token identifiers into continuous vectors, multiple attention layers that compute attention weights between token positions, feedforward layers with non-linear activation functions, and an output projection layer that maps hidden states back to token logits.

The server trains the generative AI model on training data that include pairs of input prompt sentences and target learning plans or recommendation outputs. During training, the server uses a loss function such as cross-entropy between the predicted token distribution and the target token distribution. The server updates model parameters using an optimization algorithm such as stochastic gradient descent or Adam. The server adjusts learning rates, batch sizes, and regularization parameters to achieve stable convergence and reduce overfitting. The server may apply data augmentation techniques, such as paraphrasing or injecting controlled noise into secondary features, to improve robustness.

The server stores the trained model parameters in the storage device and loads them into memory for inference. During inference, the server converts the prompt sentence into tokens, applies the trained model, and obtains output tokens. The server may constrain decoding using beam search, top-k sampling, or nucleus sampling to balance diversity and determinism.

By explicitly defining the model structure, training process, and decoding methods, the server implements a concrete computational mechanism that differs from human mental processes and enables consistent, fast, and scalable generation of learning plans.

### E. Conversion to Structured Data and Technical Advantages

The server does not rely solely on human interpretation of the generative AI outputs. Instead, the server instructs the generative AI model, via the prompt sentence, to output content in a semi-structured or structured format. For example, the server includes in the prompt sentence phrases such as “Output the plan in a structured format with the sections: Weekly Schedule, Materials, and Methods,” or “List each week as ‘Week X: . . . ’ followed by bullet points.” In some embodiments, the server instructs the generative AI model to produce a machine-readable syntax that uses predetermined markers or delimiters.

After receiving the textual output from the generative AI model, the server applies a deterministic parsing algorithm to convert the output into a structured representation. The server uses pattern matching, delimiter detection, or a parser generated for a constrained grammar to extract schedule items, material entries, and method descriptions. The server maps these extracted elements into a structured data object, such as an internal record with arrays representing weekly tasks, references to materials, and method descriptions.

This processing is not a simple display formatting step; instead, it enables downstream modules to analyze, adapt, and combine learning plans programmatically. For example, the server can compute overlaps between topics across weeks, detect inconsistencies such as missing prerequisite topics, and adjust schedules algorithmically without re-running the generative AI model. This structure-aware integration enables the server to perform incremental updates and merge newly generated segments with existing plan segments. As a result, the system reduces communication overhead and computational load because only partial regenerations are needed in many cases.

### F. Material Selection and Content Adaptation

The server selects learning materials based on the structured learning material information, the learner profile information, and the current hardware and software capabilities available at the terminal. The server maintains an index of learning materials with metadata describing format type, difficulty level, topic, and compatibility with terminal capabilities.

When the structured data from the generative AI model identifies a need for “visual explanations of quadratic functions,” the server translates this into a query over the material index. The server filters materials by topic “quadratic functions,” format type “animation” or “interactive graph,” and difficulty level matching the learner's proficiency. The server then ranks candidate materials using a scoring function that combines historical engagement metrics, similarity to learner preferences, and technical constraints such as bandwidth and display size.

By performing this matching in the server, the system offloads computation from the terminal and provides consistent behavior across different client devices. The server also reduces network traffic by selecting and transmitting only those materials that match the refined plan and terminal constraints, thereby reducing communication load compared to transmitting bulk content catalogs.

### G. Progress Analysis and Iterative Refinement

The server analyzes learning progress information and feedback information received from the terminal. The server does not merely record completion status; instead, the server computes derived indicators such as “estimated mastery level per topic,” “relative difficulty perceived by the learner,” and “time efficiency.” The server applies algorithms, such as item response theory approximations or moving averages, to translate raw data into these indicators.

The server identifies weakness areas by comparing these indicators against thresholds and patterns. For example, if the learner repeatedly fails tasks related to “word problems involving system of equations,” the server marks that topic as a weakness area and associates it with a lower mastery score. The server then generates a new prompt sentence that embeds this information explicitly, such as:

“The user has completed Week 1 of the algebra module with a difficulty rating of 4 out of 5 and 300 minutes of study time, but still frequently answers incorrectly on word problems involving systems of equations. Please update the learning plan for the next four weeks, with increased emphasis on visual breakdowns of word problems involving systems of equations, additional practice sets, and shorter explanatory segments to reduce cognitive load.”

By re-encoding machine-generated indicators into natural language instructions, the server creates a feedback loop in which each iteration refines the input to the generative AI model. This feedback loop is implemented as a deterministic algorithmic pipeline: profile update, feature extraction, prompt assembly, model inference, parsing, and plan fusion. This pipeline improves the convergence of plans toward the learner's needs and reduces the number of large-scale model inferences required, thus enhancing computation efficiency.

### H. Institution Recommendation and Integration with Learning Plans

The server acquires institution information from a storage resource. The institution information includes data structures representing types of institutions, educational content, difficulty levels, and admission requirements. The server matches this information against the learner profile information and the current learning plan to determine which institutions are realistically reachable and suitable.

The server generates a prompt sentence that integrates both the learning plan context and institutional constraints. For example, the server generates:

“The user is a visual learner who wants to enter an engineering-oriented higher education program. The user is currently at an intermediate level in mathematics and physics and aims to reach an advanced level in one year using the provided learning plan focusing on visual explanations and practice-based tasks. Based on this profile and target timeline, please suggest suitable types of educational institutions and example program characteristics, including recommended difficulty levels and typical admission requirements.”

The server provides this prompt sentence to the generative AI model, obtains recommendation information that includes candidate institution types and reasons for selection, and then cross-checks the generated information with locally stored institution information. If the generative AI model proposes institution categories or requirements that conflict with local data, the server resolves discrepancies using predefined rules, thereby ensuring technical validity and consistency in the recommendations. This combination of generated reasoning and database-backed verification improves the reliability and technical usefulness of the recommendation module.

### I. Technical Improvements Over Conventional Systems

The server implements several non-conventional operations that improve computer technology beyond mere automation of human planning. First, by standardizing the mapping from high-dimensional learner profile data and progress signals into structured prompt sentences, the server enables reproducible and traceable generative AI behavior. This improves debugging and monitoring, allowing the system to be scaled across many users without manual inspection of each output.

Second, by converting free-form generative outputs into structured data using deterministic parsing and schema-based representation, the server allows downstream algorithms to manipulate learning plans algorithmically, including partial updates and conflict resolution. This reduces the need for repeated full model inferences, thereby lowering computation time and energy consumption.

Third, by integrating performance-derived features and institution constraints into the prompt generation pipeline, the server uses the generative AI model as a component within a larger algorithmic framework. This framework leverages the model for content generation while constraining and verifying its outputs with domain-specific rules and local data, leading to more accurate and technically consistent results than naïve generative usage.

Fourth, by executing the computationally intensive parts of the process—model inference, feature extraction, and indexing—on the server, and transmitting only structured summaries and selected materials to the terminal, the system reduces communication payloads and enables responsive interfaces even over limited networks. This design provides a concrete improvement in data management and communication efficiency.

These technical effects arise from the specific arrangement and interaction of modules, data structures, and algorithms used by the server, and not merely from implementing a business concept on a computer. The server thereby provides an improved computing system for generating, adapting, and delivering personalized learning plans and institution recommendations.

### J. Alternative Embodiments and Variations

The server can implement different architectures for the generative AI model. In one variation, the server uses an encoder-only model configured for masked language modeling combined with a downstream classifier that predicts plan components, and then reconstructs a natural language plan from predicted components. In another variation, the server uses a hybrid approach in which a sequence-to-sequence model generates a skeleton plan, and a second model or rule-based module fills in details and ensures alignment with stored curriculum structures.

The server can also vary the prompt formatting strategy. In some embodiments, the server uses a fixed section order and explicit section headers to facilitate parsing. In other embodiments, the server uses a controlled vocabulary and predefined tokens that correspond to internal data fields, thereby minimizing ambiguity in the mapping from generated text to structured data.

The terminal can be implemented as a smartphone, tablet, laptop, or other computing device. The terminal may perform local preprocessing such as input validation, local caching of materials, or preliminary visualization of progress trends. The terminal may also adapt the display format based on screen size or accessibility settings, while the server remains responsible for the core plan generation, profile management, and AI inference.

The user can utilize the system in various educational contexts, such as preparation for standardized examinations, acquisition of professional skills, or continuous education. Regardless of the context, the server consistently applies the described data structures, generative AI model interactions, and algorithmic pipelines to generate and refine learning plans and recommendations.

Through these embodiments and variations, the system provides a concrete, technically implemented mechanism for leveraging a generative AI model, via structured prompt sentences and iterative refinement controlled by a server, to achieve improved computational efficiency, accuracy, and usability in personalized learning support and institution recommendation.

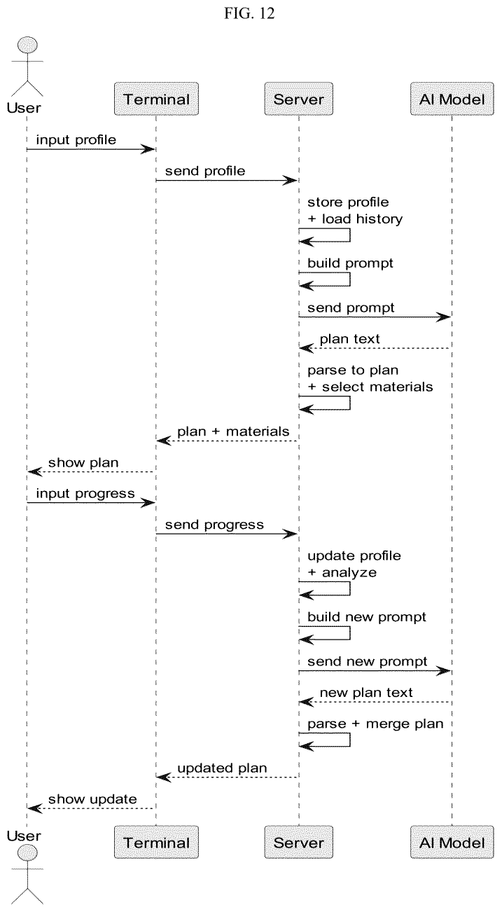

The following describes the processing flow using FIG. 12.

### Step 1:

The user operates the terminal to input learner characteristic information and learning ability information.

The terminal displays input screens and receives input such as learning style, preferred content type, target subject, current level, and goals.

The terminal uses the user's keystrokes and selections as input and converts these into a structured data object containing key-value pairs.

The terminal validates the input (for example, checks that mandatory fields are filled and that values are within allowed ranges) and outputs a validated learner profile payload.

### Step 2:

The terminal transmits the validated learner profile payload to the server.

The terminal takes the structured data object as input and serializes it into a network message.

The terminal sends the message over a communication network to a predefined server endpoint and outputs a network request containing the learner profile data.

### Step 3:

The server receives the learner profile data from the terminal.

The server uses the incoming network request as input and deserializes the payload into an internal data structure.

The server checks authentication or session information, validates field formats and allowed values, and stores the learner characteristic information and learning ability information in a storage resource.

The server outputs a stored learner profile record associated with a unique learner identifier.

### Step 4:

The server acquires past learning data and, if available, existing learning progress information and feedback information linked to the learner identifier.

The server uses the learner identifier as input to query a database for historical records, such as completed tasks, scores, and time spent.

The server aggregates and transforms these raw records into derived indicators (for example, average score per topic, time efficiency, difficulty ratings) and outputs an enriched learner profile that combines static attributes with dynamic performance metrics.

### Step 5:

The server generates a prompt sentence based on the enriched learner profile.

The server takes the enriched learner profile as input and executes a rule-based assembly algorithm that maps profile fields and indicators to textual phrases.

The server determines qualitative descriptors (such as “beginner,” “intermediate,” “still struggles with word problems”) from numerical values, concatenates these descriptors with the learner's objectives, and inserts explicit instructions for the generative AI model.

The server outputs a natural language prompt sentence, for example:

“The user is a visual learner studying high-school level mathematics to prepare for a university entrance examination in one year. The user has completed the first unit on basic algebra but still struggles with multi-step algebraic word problems and requires more visual explanations. Please generate an optimal learning plan including: (1) a week-by-week study schedule, (2) visual learning materials such as diagrams, animations, and interactive tools, and (3) step-by-step practice activities focusing on algebraic word problems.”

### Step 6:

The server tokenizes the prompt sentence and prepares input tensors for the generative AI model.

The server uses the prompt sentence as input to a tokenizer that splits the text into tokens according to a predefined vocabulary.

The server converts each token into a numerical token identifier, pads or truncates the sequence to a fixed length, and constructs one or more tensors representing token IDs and, in some embodiments, attention masks.

The server outputs model-ready input tensors that encode the prompt sentence in numerical form.

### Step 7:

The server performs inference using the generative AI model to generate a textual learning plan.

The server uses the model-ready input tensors as input to a neural network implementation, such as a transformer-based generative AI model.

The server executes matrix multiplications, attention computations, and non-linear transformations layer by layer to compute hidden states and probability distributions over the vocabulary for each output position.

The server applies a decoding strategy (for example, greedy decoding, beam search, or sampling) that iteratively selects output tokens based on the computed probability distributions until an end-of-sequence condition is satisfied.

The server outputs a sequence of output token identifiers representing the generated learning plan text.

### Step 8:

The server decodes the sequence of output token identifiers into a raw textual learning plan. The server uses the sequence of token identifiers as input to a decoder function of the tokenizer.

The server maps each token identifier back to a textual token, concatenates the tokens, and performs optional post-processing such as removing special markers or normalizing whitespace.

The server outputs a raw learning plan in natural language, containing schedule descriptions, material suggestions, and method descriptions.

### Step 9:

The server parses the raw learning plan and converts it into structured data.

The server uses the raw learning plan text as input to a parser that recognizes predefined section markers, headings, or list patterns.

The server detects segments corresponding to schedule items, learning materials, and learning methods, extracts these segments using pattern matching or a constrained grammar, and maps them into a structured schema (for example, arrays of weekly tasks and material records).

The server outputs a structured learning plan object that includes schedule information, learning material information, and learning method information in a machine-readable format.

### Step 10:

The server selects specific learning materials based on the structured learning plan and learner profile.

The server uses the learning material information, topic labels, difficulty levels, and learner preferences from the structured learning plan object as input to a retrieval component.

The server queries a material index or database, filters candidate materials by topic, difficulty, and format, computes relevance scores combining historical engagement data and learner preferences, and selects top-ranked materials.

The server outputs a list of concrete learning materials associated with identifiers, metadata, and access locations.

### Step 11:

The server composes a response that includes the structured learning plan and the selected learning materials and transmits it to the terminal.

The server uses the structured learning plan object and the selected learning materials as input and serializes them into a response payload.

The server adds additional metadata such as timestamps and model version identifiers, encodes the payload for transmission, and sends it over the communication network to the terminal.

The server outputs a network response containing the full personalized learning plan and material list.

### Step 12:

The terminal receives the response and renders the learning plan to the user.

The terminal uses the network response payload as input and deserializes it into local data structures representing schedule items, materials, and methods.

The terminal maps these data structures onto user interface components, organizes content by time period and topic, and generates visual elements such as progress bars, lists, and buttons.

The terminal outputs an interactive display that allows the user to view the plan, access materials, and navigate through the recommended learning activities.

### Step 13:

The user studies according to the presented learning plan and records progress and feedback.

The user uses the displayed tasks and materials as input guidance, performs the recommended learning activities, and then interacts with the terminal to indicate completion status, perceived difficulty, and optional comments.

The terminal converts these user actions and inputs into structured progress records, including which tasks were completed, time spent, and subjective ratings.

The terminal outputs an updated progress payload and feedback payload.

### Step 14:

The terminal transmits the progress and feedback payloads to the server.

The terminal uses the structured progress and feedback records as input, wraps them into a network message associated with the learner identifier, and sends the message to a designated server endpoint.

The terminal outputs a network request that conveys up-to-date learning progress information and feedback information.

### Step 15:

The server updates the learner profile with the new progress and feedback information.

The server uses the incoming progress and feedback payloads as input, locates the corresponding learner profile record, and appends or merges the new records into the historical data.

The server recalculates derived indicators such as mastery levels, difficulty trends, and schedule adherence, and stores the updated values in the learner profile.

The server outputs an updated learner profile that reflects the learner's current state.

### Step 16:

The server generates an updated prompt sentence that incorporates the updated learner profile.

The server uses the updated learner profile, including newly computed weakness areas and achievement levels, as input to the prompt generation algorithm.

The server determines which topics need reinforcement, how the schedule should be adjusted, and which learning methods require modification, and encodes these determinations in a new prompt sentence.

The server outputs an updated prompt sentence, for example:

“The user is a visual learner studying high-school mathematics to prepare for a university entrance examination in one year. The user has completed Week 1 with a difficulty rating of 4 out of 5 and 300 minutes of study time, but still frequently answers incorrectly on word problems involving systems of equations. Please update the learning plan for the next four weeks, with increased emphasis on visual breakdowns of word problems involving systems of equations, additional practice sets, and shorter explanatory segments to reduce cognitive load.”

### Step 17:

The server re-invokes the generative AI model using the updated prompt sentence and refines the learning plan.

The server uses the updated prompt sentence as input, repeats tokenization and tensor preparation, and performs model inference as in previous steps.

The server obtains a new sequence of output token identifiers that correspond to an updated learning plan, decodes this sequence into text, and parses it into structured data.

The server outputs an updated structured learning plan that modifies and extends the previous plan based on the learner's recent performance.

### Step 18:

The server merges the updated structured learning plan with the existing plan and sends the changes to the terminal.

The server uses the existing structured learning plan and the updated structured learning plan as input, compares their components, and identifies new or modified schedule items and materials.

The server applies merging rules to preserve completed tasks, adjust future tasks, and avoid duplication, and generates a differential update or a refreshed full plan.

The server outputs a new response payload containing the refined plan, which the server transmits to the terminal for display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning management techniques primarily function as static record-keeping tools that store scores and timestamps and then present simple summaries such as total study time or average test scores. Such techniques typically rely on fixed rule engines or manually designed recommendation logic that cannot flexibly adapt to complex, evolving learning patterns of individual learners. As a result, conventional systems exhibit several technical limitations at the level of data processing and system behavior.

First, conventional systems do not perform integrated, automated processing that transforms raw, heterogeneous learning logs into machine-usable, structured context for a generative AI model. Learning logs, learner attributes, and progress indicators are often stored in separate subsystems and require manual curation before being passed to any intelligent engine. This fragmented data flow leads to inefficient use of computational resources and limits the ability of the system to automatically reconfigure itself based on new data. In particular, prompt sentences for generative AI models are often handcrafted and static, and are not programmatically generated from real-time learning history and computed metrics, which restricts the precision and responsiveness of AI-generated learning plans.

Second, conventional systems lack a closed-loop, programmatic feedback mechanism that uses learner feedback and operational constraints to dynamically update both the underlying data representations and the prompts sent to a generative AI model. While some systems may allow a learner to rate content or adjust schedule parameters, the feedback is typically not integrated into the computational pipeline that governs the generation of prompts and learning plans. This results in a technical deficiency where the system state (e.g., stored learning history, computed indices, and active plans) does not self-adapt based on user feedback in a systematic, machine-driven fashion.

Third, visualization and recommendation functions in conventional systems are often implemented as separate modules without deep coupling to data analysis and AI-based plan generation. Score graphs and time charts may be computed, but they are not tightly integrated with the prompt-generation process and the downstream selection of educational content. Consequently, the system fails to leverage its computed metrics (such as weakness indices or time-allocation discrepancies) to automatically influence how prompts are constructed and how generative AI outputs are interpreted and transformed into structured learning plans.

Fourth, conventional architectures that incorporate AI-based recommendations often treat the AI model as a black-box endpoint for natural language output, without providing a structured mechanism to convert AI-generated text into machine-usable learning plan data that can be versioned, compared, and incrementally updated. This leads to technical inefficiencies, including repeated manual parsing or ad hoc string handling, which increases latency and reduces reliability in delivering updated plans to terminal devices.

Therefore, there is a need for an improved computer-implemented learning support system that: (i) programmatically collects and unifies learning history information and learner attributes; (ii) computes quantitative indicators such as progress indices and weakness indices using statistical and numerical operations; (iii) automatically constructs prompt sentences for a generative AI model based on these computed indicators; (iv) converts AI-generated outputs into structured, versioned learning plan data; (v) dynamically updates the learning plan data by incorporating learner feedback and constraint conditions; and (vi) tightly integrates visualization, content selection, and AI-based plan generation within a single closed-loop computational pipeline. Such a system would improve the functioning of the computer itself by enabling more efficient data flow, automated prompt engineering, and adaptive plan management, thereby enhancing performance and scalability in learning support applications.

The specific processing by the specific processing unit 290 of the data processing device 12 in Example 2 is realized by the following means.

The present invention provides a server comprising a processor, a storage device, and a communication interface, the processor being configured to acquire learning history information transmitted from an information terminal device used by a learner and store the learning history information in the storage device; to analyze, by executing statistical processing and numerical computation, the learning history information and learner attribute information stored in the storage device to calculate learning time information, evaluation information, progress indices, and weakness indices for the learner; to generate progress display data by converting calculation results of the learning time information, the evaluation information, the progress indices, and the weakness indices into graphical information representing a learning progress state of the learner on a time axis and per learning domain, and to output the progress display data to the information terminal device via the communication interface; to generate a prompt sentence configured to instruct a generative AI model to generate learning plan information based on the learning history information, the learner attribute information, and the calculated indices, to input the prompt sentence and at least part of the learning history information to the generative AI model via the communication interface, and to acquire the learning plan information output from the generative AI model; to convert the learning plan information into structured learning plan data including learning time allocation information and learning activity content information for each learning domain, to store the structured learning plan data in the storage device, to select educational content information corresponding to the structured learning plan data, and to provide the educational content information to the information terminal device via the communication interface; and to acquire, from the information terminal device via the communication interface, evaluation information and constraint condition information relating to the structured learning plan data, to associate the evaluation information and the constraint condition information with the learning history information in the storage device, to generate an update prompt sentence reflecting the evaluation information and the constraint condition information, to input the update prompt sentence to the generative AI model, and to dynamically update the structured learning plan data based on updated learning plan information output from the generative AI model. This enables a closed-loop, computer-implemented learning support process in which raw learning logs are transformed into computed indices, automatically encoded into prompt sentences for a generative AI model, converted into structured and versioned learning plans, and adaptively revised based on learner feedback and constraints, thereby improving the efficiency, responsiveness, and technical performance of the learning support system.

The term “system” refers to an arrangement of hardware and software components including at least one processor, a storage device, and a communication interface, configured to execute the described learning support functions as an integrated whole.

The term “processor” refers to one or more hardware-based processing units, such as a central processing unit or a programmable logic device, configured to execute machine-readable instructions to perform data acquisition, analysis, prompt generation, model interaction, plan generation, and updating operations.

The term “storage device” refers to a non-transitory computer-readable medium, such as a magnetic disk, an optical disk, a semiconductor memory, or a combination thereof, configured to store programs, learning history information, learner attribute information, learning plan data, and related control information.

The term “communication interface” refers to a hardware and software communication component configured to send and receive data between the system and external devices or services via wired or wireless communication networks.

The term “information terminal device” refers to a user-operated electronic device, such as a portable communication device, a personal computer, or a tablet device, configured to transmit learning activity information to the system and to receive progress display data, educational content information, and learning plan information from the system.

The term “learner” refers to an individual user who performs learning activities using the information terminal device and whose learning history information and attributes are processed by the system.

The term “learning history information” refers to electronically stored data representing past learning activities of the learner, including at least time information, content identifiers, subject identifiers, performance results, and other activity parameters.

The term “learning activity information” refers to data items indicating specific actions taken by the learner, such as starting or ending a study session, accessing a particular content item, answering an assessment item, and obtaining a score.

The term “learner attribute information” refers to information describing characteristics of the learner, including at least age, grade level, learning goals, available study time, and other profile parameters used for analysis and plan generation.

The term “evaluation information” refers to data representing performance measures of the learner, including test scores, assessment results, correctness ratios, and other quantitative indicators of learning outcomes.

The term “learning time information” refers to data indicating time durations associated with learning activities, including total study time, per-subject study time, and time distributions over specified periods.

The term “progress index” refers to a computed metric indicating a degree of advancement of the learner toward a learning goal, including indices based on score transitions, completion rates, or cumulative study time.

The term “weakness index” refers to a computed metric indicating a relative deficiency or low performance region for the learner, determined based on evaluation information, progress indices, and learning time information for each learning domain.

The term “statistical processing” refers to computational procedures that apply statistical methods to data, including aggregation, grouping, averaging, variance and standard deviation computation, trend detection, and other statistical analyses.

The term “numerical computation” refers to computational procedures that perform arithmetic and numerical operations on data, including summation, subtraction, multiplication, division, threshold comparison, and other quantitative calculations.

The term “graphical information” refers to data representing visual elements such as graphs, charts, tables, and diagrams that can be rendered on a display device to represent learning progress states and related metrics.

The term “progress display data” refers to data structures containing graphical information that visualize the learner's progress, including time-series graphs of scores, bar charts of learning time, and other visual representations suitable for display on the information terminal device.

The term “learning domain” refers to a classification unit for learning content, such as a subject, topic, skill category, or sub-domain, used to group and analyze learning activities and results.

The term “generative AI model” refers to a machine learning model, implemented in software on computing hardware and trained on data, that generates textual or structured output in response to input data and instructions, including generative language models configured to produce learning plan information.

The term “prompt sentence” refers to a machine-generated or machine-processed textual instruction sequence, including one or more sentences, that is provided as input to a generative AI model to specify a requested output, such as learning plan information, weakness region information, or recommendation information.

The term “learning plan information” refers to information output by the generative AI model that describes a proposed learning schedule, recommended topics, study methods, and time allocations for the learner.

The term “structured learning plan data” refers to learning plan information that has been converted into a predefined data format, including fields or records describing learning time allocation, learning activities, and target learning domains, suitable for storage, retrieval, and programmatic updating.

The term “learning time allocation information” refers to data specifying assigned study durations for each learning domain or time period, such as hours per week or minutes per session.

The term “learning activity content information” refers to data describing specific learning actions to be performed by the learner, such as reviewing concepts, solving practice problems, or taking assessments, associated with corresponding learning domains and time periods.

The term “educational content information” refers to information identifying or describing instructional resources, such as digital learning materials, practice items, and explanatory content, which can be provided to the learner according to the structured learning plan data.

The term “evaluation information relating to the learning plan data” refers to feedback information provided by the learner or derived by the system that indicates satisfaction level, perceived difficulty, or effectiveness of the current learning plan.

The term “constraint condition information” refers to information specifying limitations or preferences that affect the learning plan, including available study time, preferred study periods, content difficulty constraints, or device usage restrictions.

The term “update prompt sentence” refers to a prompt sentence generated by the processor that incorporates evaluation information and constraint condition information and is used to instruct the generative AI model to output updated learning plan information.

The term “updated learning plan information” refers to revised learning plan content produced by the generative AI model in response to an update prompt sentence, reflecting changes in constraints, feedback, or learning status.

The term “organization information” refers to information regarding an educational organization, including attributes such as institution type, location, admission requirements, curriculum characteristics, and performance indicators.

The term “organization information storage device” refers to a storage device or storage area configured to store organization information related to educational organizations.

The term “target condition information” refers to information describing desired conditions or goals of the learner, such as target examination scores, preferred institution type, budget level, or enrollment period, used for recommendation and plan adjustment.

The term “educational organization candidate” refers to an educational organization that is identified as satisfying at least part of the target condition information and is suitable for recommendation to the learner.

The term “recommendation information” refers to information that identifies one or more educational organization candidates and may include comparative attributes, suitability scores, or explanatory notes.

The term “learning plan adjustment proposal” refers to information that describes modifications to the structured learning plan data, such as changes in subjects, topics, or schedules, adjusted to align with characteristics of recommended educational organization candidates.

In one embodiment, a server, one or more terminals, and a communication network constitute a learning support system. The server includes at least one processor, a main memory, a non-transitory storage device, and a communication interface. The terminal includes a processor, a display, an input device, a local storage, and a communication interface. The user operates the terminal to perform learning activities, and the server executes a program stored on the storage device to implement the functions described below.

The server executes an operating system such as Linux and application software implemented, for example, using a web application framework such as a Python-based framework. The server uses database software such as a relational database management system (for example, MySQL) as the storage device for storing learning history information, learner attribute information, analysis results, and structured learning plan data. The server uses scripting and data analysis libraries such as Python, Pandas, and NumPy to perform data aggregation and numerical computation. The server optionally uses a visualization tool such as Tableau or an equivalent visualization library to generate progress display data. The server communicates with a generative AI model hosted either locally or by an external AI service through an application programming interface.

The terminal executes an operating system such as Android or iOS and a learning application. The terminal records learning activity information and transmits the learning activity information to the server. The user logs into the learning application, selects learning content, performs study sessions, and views progress displays and learning plans.

The server stores programs for implementing the described functions on the storage device. The processor of the server loads these programs into the main memory and executes them. The server defines data structures such as:
A user table including fields such as user identifier, age, grade level, and target examination date.
A learning session table including fields such as session identifier, user identifier, subject code, content identifier, start timestamp, end timestamp, and computed duration.
A test result table including fields such as result identifier, user identifier, subject code, score, maximum score, test type, and test timestamp.
An analysis table including fields such as user identifier, subject code, weekly study time, average score, score trend, progress index, and weakness index.
A learning plan table including fields such as plan identifier, user identifier, version number, plan creation timestamp, learning time allocation per subject, daily activity descriptions, status, and relation to previous plans.
A feedback table including fields such as feedback identifier, user identifier, plan identifier, rating, free-text feedback, and updated constraint conditions.

The server uses these data structures to manage learning history information and learning plan data in a form enabling efficient query and update operations.

The terminal records learning activity information using its local system clock, input components, and local storage. The terminal stores each learning event as a record including at least a timestamp, a content identifier, a subject identifier, and an event type (such as “session start,” “session end,” or “test completed”). The terminal aggregates such records into learning session information and periodically transmits the aggregated learning session information to the server via the communication interface using a protocol such as HTTPS.

The server receives learning history information via the communication interface and parses the information using a web application module. The server validates the data types, checks required fields, and discards or corrects data with invalid timestamps or out-of-range scores. The server stores valid learning history information in the database through insert and update commands. The server computes derived fields such as session duration by subtracting the start timestamp from the end timestamp using numerical computation functions.

The server uses the data analysis libraries to transform the stored learning history information into analysis results. The server loads relevant records from the database into an in-memory table representation such as a Pandas DataFrame. The server groups data by user identifier, subject code, and time period (for example, calendar week) and computes the total duration of learning sessions within each group, the average scores, and the variance of scores. The server computes progress indices by, for example, fitting a linear regression line to recent scores per subject and using the slope and intercept as numerical indicators of improvement or decline. The server computes weakness indices by combining normalized average scores and normalized study times and assigning higher weakness indices to subjects with low scores and insufficient study time.

The server uses such computed indices as features representing the learner's state. The server stores the analysis results, including progress indices and weakness indices, in the analysis table. The server thereby reduces the need to recompute statistics for every request and improves response speed.

The server generates progress display data by converting analysis results into graphical information. The server either exports aggregated data to a visualization tool or directly uses a visualization library to generate images or structured graph data such as line charts and bar charts. The progress display data includes, for example, a time-series line graph of scores per subject, a bar chart of weekly study time, and a colored indicator representing the weakness index per subject. The server sends this progress display data to the terminal, and the terminal renders the progress display data on the display. The user views the graphs and can understand, for example, that mathematics scores have decreased over the last three tests while study time has remained low.

The server uses a generative AI model to generate learning plan information based on the learning history information, learner attribute information, and analysis results. In one embodiment, the generative AI model is a neural-network-based language model with a transformer architecture, including multiple layers of self-attention, feedforward sublayers, and layer normalization. The model is trained on large-scale text data using a sequence-to-sequence objective to predict the next token in a sequence given previous tokens. The model parameters include at least tens of millions or more weight values representing attention matrices, projection matrices, and feedforward layer weights. The model uses position encodings, multi-head attention, and layer-wise residual connections.

The server prepares input to the generative AI model as a prompt sentence. The prompt sentence includes plain-language descriptions of the learner profile, learning history, and computed indices, together with explicit instructions on the desired output format. For example, the server generates a prompt sentence such as:

“You are an expert learning coach.

The learner is a high school student who recently scored 45 out of 100 on an algebra test.

The learner's mathematics scores over the last three tests are [45, 52, 48], and the learner studies mathematics about 2 hours per week.

The learner has 7 additional hours per week available for study.

Please propose a 4-week mathematics study plan focused on algebra.

The plan must specify weekly study hours, break down the plan into daily tasks, include topic names (for example, linear equations, quadratic functions), and include recommendations for practice types (for example, problem sets, concept review).

Output the plan as a structured bullet list.”

The server constructs such a prompt sentence by programmatically combining template sentences and variable fields populated from the database. The server tokenizes the prompt sentence into a sequence of token identifiers using a tokenizer consistent with the generative AI model. The server transmits the token identifiers via the communication interface as input to the generative AI model hosted on an AI computing resource.

The generative AI model processes the token sequence using its transformer layers. Each layer computes attention scores between tokens, aggregates contextual information, and updates hidden state vectors. The model uses learned weight matrices to compute these operations. The model outputs a sequence of token probability distributions from which the server or AI host selects the most likely tokens or samples tokens under preconfigured parameters (such as temperature and top-k or top-p values). The server receives the final token sequence as learning plan information and decodes the sequence into text.

The server converts the learning plan information into structured learning plan data. The server may instruct the generative AI model via the prompt sentence to use a constrained textual format such as numbered lists or labeled segments, which facilitates deterministic parsing. The server parses the output text to extract, for example, per-week and per-day entries, each entry including a subject, a topic, and a planned study duration. The server converts these entries into structured records and stores them in the learning plan table as machine-usable data. This conversion enables efficient indexing, comparison between versions, and incremental adaptation of the plan.

The server associates the structured learning plan data with educational content information. For example, the server maps identified topics (such as “linear equations” or “fraction operations”) to content identifiers in a content catalog table stored in the database. The server selects content items whose difficulty levels and estimated completion times match the planned activities. The server transmits references to these educational content items to the terminal along with the structured learning plan data. The terminal displays the learning schedule and provides links or buttons that allow the user to open the corresponding content items.

The user reviews the learning plan on the terminal. The user can evaluate the plan by entering a rating or textual feedback, such as “The weekday study time is too long” or “I want to focus more on geometry.” The terminal transmits the evaluation information and updated constraint condition information (such as maximum available time per day) to the server. The server stores this feedback in the feedback table and associates it with the previous learning plan version.

The server generates an update prompt sentence that incorporates the evaluation information and constraint condition information. The server, for example, composes a prompt sentence such as:

“The previous mathematics study plan required 3 hours of study each weekday, but the learner can only study 30 minutes on weekdays and 90 minutes on weekends.

The learner's main goal is to improve algebra test scores from about 45 to at least 70 within one month.

Please revise the 4-week mathematics study plan to respect the new time limits while keeping algebra as the highest priority subject.

Output a 4-week schedule with daily tasks that fit within the available time.”

The server again tokenizes this update prompt sentence and sends it to the generative AI model. The model generates updated learning plan information that reflects the new time constraints. The server parses and converts the updated learning plan information into structured learning plan data and stores it as a new version in the learning plan table while marking the previous plan as superseded. The server thereby maintains versioned histories of learning plans and supports traceability of changes.

The described configuration improves computer technology in several ways. The server uses specific data structures and analysis pipelines to precompute progress indices and weakness indices. This precomputation reduces the size and complexity of prompt sentences and enables the generative AI model to focus on high-level planning rather than basic aggregation. As a result, the amount of data sent to the AI host and the processing time needed for each AI inference are reduced, which improves system throughput and reduces network load.

The server employs a closed-loop feedback mechanism implemented at the data-structure and algorithm levels. The server does not simply automate human planning; instead, the server uses non-conventional prompt construction rules that combine quantitative indices (such as regression-derived trend values, normalized weakness scores, and detailed time allocations) with textual constraints. This hybrid representation cannot be easily emulated by manual planning and leads to more precise control of generative outputs. The server thereby reduces variance and error in generated plans and increases consistency across repeated AI calls.

The server defines a clear separation between raw logs, computed metrics, and structured plans, and it uses an explicit transformation pipeline to move data between these layers. This layered data flow simplifies caching, parallelization, and incremental updates and results in faster updates when new learning activity information or feedback arrives. The server can recompute only the affected metrics and regenerate only the necessary parts of the prompt sentence or plan, rather than recomputing the entire plan from scratch, thereby improving computational efficiency.

The generative AI model is not treated as an opaque decision-maker. The server constrains the model by:
pre-filtering and compressing input data into explicit summary statistics,
explicitly specifying required output structures in the prompt sentence, and
parsing model outputs into strict data formats.

This structured interaction reduces the risk of ambiguous or irrelevant outputs and enables the server to perform deterministic validation and correction of model outputs. This, in turn, leads to fewer invalid plans transmitted to terminals and fewer correction cycles, thereby reducing resource consumption.

In one embodiment, the server uses training data including historical learning history information and learning plan information pairs to fine-tune the generative AI model. The server uses a loss function such as cross-entropy between predicted tokens and ground-truth plan tokens, and uses gradient-based optimization (for example, stochastic gradient descent or an adaptive optimization algorithm) to update model weights. The server may use data augmentation techniques such as adding noise to time allocations, shuffling equivalent activities, or paraphrasing plan descriptions to increase robustness of the model to variation in prompt sentences. This configuration improves the accuracy and stability of generated learning plans under diverse learner profiles.

In another embodiment, the server uses rule-based modules to post-process generative outputs. For example, the server applies constraints such as “total daily time per learner must not exceed the stored maximum available time” and “each subject with a weakness index above a threshold must appear at least a specified number of times per week.” These constraints are implemented as formal rules applied to structured plan data after parsing. If the generative AI model outputs a plan that violates such constraints, the server programmatically adjusts time allocations or requests a corrected plan by generating a new update prompt sentence. This hybrid approach combines generative flexibility with deterministic rule enforcement and yields technically improved control over plan quality.

The system is not limited to learning applications. In alternative embodiments, the server uses similar data structures and processing flows to support individualized training in other domains, such as professional skill development or rehabilitation exercises. The key technical concepts—programmatic prompt sentence generation based on computed indices, structured conversion of generative outputs, and closed-loop feedback-based updating—remain applicable.

In another embodiment, the server executes the generative AI model locally on hardware accelerators such as graphics processing units or tensor processing units. The server then stores model parameters on the storage device and loads them into accelerator memory at runtime. The server uses optimized numerical libraries to perform matrix multiplications and attention computations. This configuration reduces latency and provides improved control over data privacy.

The described embodiments exemplify specific ways in which the server, the terminal, and the user cooperate to implement the invention. The invention is not limited to these examples. The server can use different database engines, different generative AI models, different visualization tools, and different communication protocols, as long as the server implements the same fundamental mechanisms: collection and analysis of learning history information, generation of prompt sentences for a generative AI model based on computed metrics, conversion of generative outputs into structured learning plan data, and dynamic updating of the learning plan data using learner feedback and constraint conditions.

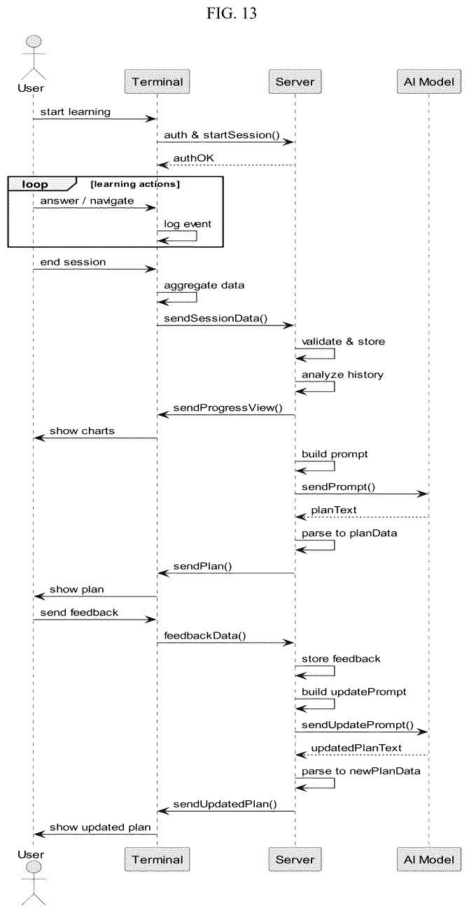

The following describes the processing flow using FIG. 13.

### Step 1:

The user starts a learning session on the terminal. The terminal receives a user selection of content (subject, unit, test) and records a start timestamp using the terminal's system clock. The terminal sets an internal session identifier and stores an initial learning activity record in local storage.

Input: user ID, selected content ID, current time.

Output: locally stored learning activity record including user ID, content ID, session start time, and session ID.

### Step 2:

The user performs learning activities and assessments through the terminal. The terminal records each event such as answering a question, moving to the next page, or submitting a test. The terminal updates or appends local records for the active session.

Input: user interactions (answers, navigation events), session ID, timestamps.

Output: updated local learning activity records including per-item results and event timestamps.

### Step 3:

The user finishes the learning session. The terminal records a session end timestamp and computes a session duration by subtracting the start time from the end time. The terminal aggregates per-event records into a summarized learning session record and a summarized test result record when applicable.

Input: session start time, session end time, per-event records.

Output: aggregated learning session data including total duration, number of items, and optional test score summary.

### Step 4:

The terminal transmits learning history information to the server. The terminal packages one or more aggregated session records and test results into a message and sends the message to the server via the communication interface using a network protocol. The terminal awaits an acknowledgment from the server.

Input: aggregated learning session data, user authentication token.

Output: network request containing learning history information sent to the server.

### Step 5:

The server receives the learning history information from the terminal. The server parses the incoming message, validates fields such as user ID, timestamps, and scores, and discards or flags invalid records. The server performs basic normalization, such as converting times to a standard time zone.

Input: learning history information transmitted from the terminal.

Output: validated and normalized learning history records ready for database insertion.

### Step 6:

The server stores the validated learning history information in the storage device. The server maps each record to database tables such as a user table, a learning session table, and a test result table. The server executes insert operations and ensures referential integrity by linking records through user IDs and session IDs.

Input: validated learning history records.

Output: persistent database entries representing the learner's past learning activities.

### Step 7:

The server retrieves learner attribute information and existing history for analysis. The server queries the database for records related to the target user over a predefined period, and retrieves user profile data such as age, grade, and study goals.

Input: user ID, query parameters (time range, subject filters).

Output: in-memory collections of learning sessions, test results, and learner attributes for the user.

### Step 8:

The server computes learning time information using numerical operations. The server groups learning sessions by subject and time period (for example, per week) and calculates total study duration for each group by summing session durations. The server stores these aggregated values as learning time information.

Input: learning session records for the user.

Output: learning time information including per-subject, per-period total study durations.

### Step 9:

The server computes evaluation information from test results. The server groups test result records by subject and time period and calculates statistics such as average score, maximum score, minimum score, and number of attempts. The server uses numerical computation to derive evaluation information.

Input: test result records for the user.

Output: evaluation information including aggregated scores and related statistics per subject.

### Step 10:

The server calculates progress indices based on learning time information and evaluation information. The server applies statistical processing to time-series score data to compute trends such as score slopes and moving averages. The server assigns progress indices that numerically represent improvement, stagnation, or decline for each subject.

Input: per-subject time-series scores and study times.

Output: progress indices per subject indicating advancement or regression.

### Step 11:

The server calculates weakness indices. The server combines normalized scores and normalized study times, for example by assigning higher weakness scores to low-score, low-time combinations and lower weakness scores to high-score, sufficient-time combinations. The server sets threshold-based flags for subjects that require priority attention.

Input: evaluation information and learning time information.

Output: weakness indices and flags indicating weak learning domains.

### Step 12:

The server stores analysis results in an analysis table. The server writes computed learning time information, evaluation information, progress indices, and weakness indices into structured records. The server associates each record with a user ID and subject code.

Input: computed metrics (learning time, evaluation, progress indices, weakness indices).

Output: persistent analysis records accessible for subsequent visualization and plan generation.

### Step 13:

The server generates progress display data. The server loads analysis records and converts them into graphical data representations, such as time-series data points for a line chart and aggregated values for bar charts. The server uses visualization software or libraries to generate chart configurations or images.

Input: analysis records per user and per subject.

Output: progress display data specifying graphical structures for rendering learning progress and weaknesses.

### Step 14:

The server sends progress display data to the terminal. The server packages the constructed chart data or image references into a response message and transmits it to the terminal. The terminal receives the message and uses local rendering functions to display graphs and indicators on the screen.

Input: progress display data stored or generated by the server.

Output: rendered visualizations on the terminal indicating the learner's progress and weak areas.

### Step 15:

The server constructs a prompt sentence for a generative AI model. The server retrieves relevant analysis results and learner attribute information and inserts them into a textual template. The server generates a coherent prompt sentence that includes the learner's current performance, learning time, goals, and required output structure.

Input: analysis records and learner attributes.

Output: a prompt sentence specifying context and instructions for generating a learning plan.

### Step 16:

The server tokenizes and sends the prompt sentence to the generative AI model. The server converts the prompt sentence into a sequence of tokens recognized by the model and transmits the token sequence via the communication interface to the AI computation environment.

Input: prompt sentence in natural language.

Output: tokenized prompt data delivered to the generative AI model.

### Step 17:

The server receives learning plan information from the generative AI model. The generative AI model outputs a sequence of tokens representing a proposed learning plan. The server decodes the tokens back into text and treats this text as learning plan information.

Input: output token sequence from the generative AI model.

Output: textual learning plan information describing schedule, topics, and recommended activities.

### Step 18:

The server parses the learning plan information into structured learning plan data. The server analyzes the text for structural markers such as weeks, days, subjects, and durations, and converts them into structured records with fields for subject, topic, time allocation, and activity type.

Input: textual learning plan information.

Output: structured learning plan data stored in learning plan records.

### Step 19:

The server associates educational content information with the structured learning plan data. The server maps topics and subjects in the plan to content entries in a content catalog and filters content items by difficulty and estimated duration to match plan entries.

Input: structured learning plan data and content catalog records.

Output: linked learning plan records with associated content identifiers for each recommended activity.

### Step 20:

The server sends the structured learning plan data and associated educational content information to the terminal. The server constructs a response including per-day activity items, each with a subject, topic, planned duration, and content link. The terminal receives this data and renders a schedule and links on the user interface.

Input: structured learning plan records and content identifiers.

Output: displayed learning plan and content access options on the terminal.

### Step 21:

The user reviews the learning plan and provides feedback via the terminal. The terminal presents options to rate the plan and to enter constraint conditions such as available study time or subject preference. The terminal packages the feedback into a message and sends it to the server.

Input: user-provided ratings, comments, and constraint conditions.

Output: feedback data transmitted from the terminal to the server.

### Step 22:

The server stores feedback and updated constraint conditions. The server records the feedback in a feedback table and updates or adds constraint entries associated with the current user and learning plan version.

Input: feedback data and constraint information from the terminal.

Output: persistent feedback records and updated constraint condition records.

### Step 23:

The server generates an update prompt sentence that reflects the feedback and constraints. The server analyzes the difference between the original plan and the new constraints, identifies conflicts such as excessive daily time, and embeds this information into a revised textual instruction.

Input: previous learning plan data, feedback records, constraint conditions.

Output: update prompt sentence instructing the generative AI model to revise the learning plan.

### Step 24:

The server sends the update prompt sentence to the generative AI model and receives updated learning plan information. The server tokenizes the update prompt sentence, calls the generative AI model, and decodes the result into text once again, now representing an adjusted plan that accounts for the new constraints.

Input: update prompt sentence.

Output: textual updated learning plan information.

### Step 25:

The server parses and stores the updated learning plan data and deactivates the previous plan version. The server converts the updated learning plan information into structured records as before, assigns a new version identifier, and sets a status flag indicating that the new plan is active. The server marks the old plan as superseded.

Input: updated learning plan information and existing plan records.

Output: new structured learning plan data version and updated status flags for all related plans.

### Step 26:

The server transmits the updated learning plan data to the terminal, and the terminal updates the display accordingly. The user sees the revised schedule reflecting time and preference constraints. The terminal replaces or annotates obsolete plan entries to avoid confusion.

Input: updated structured learning plan data from the server.

Output: revised plan presentation on the terminal aligned with user feedback and constraints.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented learning support systems, a processor typically analyzes only coarse academic performance indicators, such as test scores or completion counts, and applies fixed heuristic rules to update learning plans. Such systems suffer from several technical limitations.

First, the processor generally treats learning logs, user profile data, and any emotion-related signals as separate, weakly coupled data streams. As a result, the system cannot construct unified machine-processable representations that coherently capture the user's learning tendency, weak domain, and emotion state. This fragmentation leads to inefficient data usage and requires multiple disjoint analysis pipelines, increasing processing latency and computational overhead.

Second, conventional systems lack a systematic mechanism to generate structured input instructions for a generative AI model. In many cases, either no generative AI model is used or, when used, free-form text is manually authored or minimally templated. The processor is therefore unable to automatically construct precise, context-rich prompt sentences that encode current learning history, identified weaknesses, and emotion states as machine-interpretable constraints. This results in suboptimal or inconsistent learning plans and feedback, and in an inability to reliably automate plan generation and revision.

Third, existing architectures usually rely on static, rule-based plan adjustment that is not tightly coupled with real-time learning execution history. The processor does not dynamically translate updated telemetry, such as per-content performance and session-level signals, into new prompt sentences for the generative AI model. Consequently, the system cannot maintain an up-to-date learning plan that continuously adapts to fine-grained behavioral changes, and cannot efficiently re-use previously computed analysis to drive iterative plan refinement.

Fourth, conventional systems rarely integrate an emotion analysis engine into the core planning loop at the processor level. Emotion information, when present, is often used only for simple threshold-based alerts and is not fed as structured constraints into the generation of learning plans or feedback. This prevents the processor from adjusting parameters such as learning time, difficulty level, and content type in a programmatic and data-driven way, which reduces the technical effectiveness of the personalization logic and wastes available multimodal signals.

Fifth, existing recommendation modules for educational institutions and services are commonly implemented as separate subsystems that do not leverage the same integrated user model. They tend to operate on simple filters or static scoring functions, without the ability to use generative AI models to produce machine-generated comparative reasoning based on the user's detailed learning history, emotion state, and usage conditions. Thus, the processor cannot generate scalable, context-aware recommendation explanations and cannot technically unify learning plan generation, feedback, and service recommendation under a common generative prompting pipeline.

Accordingly, there is a need for an improved computer-implemented system in which the processor: (i) integrates learning information and emotion information into a unified representation, (ii) automatically generates structured prompt sentences for a generative AI model to obtain learning plans, feedback, and recommendations, (iii) dynamically updates those plans based on continuous learning execution history and emotion states, and (iv) programmatically associates generative outputs with machine-readable task sequences and content resources. Such improvements would enhance the efficiency, adaptability, and scalability of the underlying computer system, reduce manual configuration, and enable more accurate and responsive control of the generative AI model through automatically generated prompt sentences.

The specific processing by the specific processing unit 290 of the data processing device 12 in Application Example 2 is realized by the following means.

The present invention provides a server comprising a processor configured to acquire and store learning information and emotion information relating to each user from one or more user terminals; to analyze integrated information including the learning information and the emotion information so as to identify, for each user, at least a learning tendency, a weak domain, and an emotion state; to automatically generate, based on the integrated information and the identified learning tendency, weak domain, and emotion state, a prompt sentence for a generative AI model, the prompt sentence instructing the generative AI model to generate a learning plan under specified constraints; to receive a learning plan output from the generative AI model in response to the prompt sentence and convert the learning plan into a machine-readable format; to associate individual learning items in the converted learning plan with educational resources in a learning content database and thereby construct a sequence of specific learning tasks for each user; to deliver the constructed sequence of learning tasks to the corresponding user terminal and continuously collect a learning execution history from the user terminal; to dynamically update the learning plan by generating, on the basis of the learning execution history and the emotion information, an update prompt sentence including conditions for adjusting at least one of learning time, difficulty level, and content type, inputting the update prompt sentence to the generative AI model, and obtaining a revised learning plan; and to generate indicator data and display data for visualizing learning progress and the weak domain based on analysis results and provide the display data to the user terminal. This enables the computer system to internally integrate heterogeneous user signals into unified representations, to automatically and repeatedly construct high-fidelity prompt sentences that control a generative AI model, to convert generative outputs into executable task sequences bound to concrete content resources, and to continuously adapt learning plans, feedback, and educational service recommendations in real time, thereby improving the technical performance, responsiveness, and automation level of the learning support infrastructure.

The term “learning information” refers to data representing a user's learning activities, including at least study time, content identifiers, subjects, topics, test or quiz scores, completion states, and temporal information associated with learning sessions.

The term “emotion information” refers to data representing a user's emotion or psychological state during or related to learning, including information derived from sensor inputs, behavioral logs, self-reports, or other signals indicating stress, motivation, anxiety, boredom, confidence, or similar emotion states.

The term “integrated information” refers to a data structure in which learning information and emotion information relating to a user are combined, normalized, and stored in association with each other so that they can be jointly processed by the processor.

The term “learning tendency” refers to a characteristic pattern of a user's learning behavior, including at least preferred content types, typical study duration, frequency of study sessions, and performance evolution over time for one or more subjects or topics.

The term “weak domain” refers to a subject, topic, skill, or content category in which a user's learning performance, such as accuracy, score, or completion quality, is below a predetermined threshold compared to other domains or to a target level.

The term “emotion state” refers to a categorized representation of a user's current or recent emotion, such as stressed, relaxed, motivated, demotivated, bored, or anxious, optionally associated with a confidence value or intensity level.

The term “prompt sentence” refers to a machine-generated natural-language instruction or query, formatted as text, that is provided as input to a generative AI model to specify a task, constraints, and context for generating an output such as a learning plan, feedback, or recommendation.

The term “generative AI model” refers to a computational model that uses machine learning techniques to generate output data, including natural-language text, in response to an input prompt sentence, and that is capable of producing novel learning plans, feedback, or explanations conditioned on the input.

The term “learning plan” refers to a structured arrangement of learning actions for a user over a period of time, including at least a schedule, topics to be studied, suggested durations, and recommended content types.

The term “machine-readable format” refers to a structured representation of data, such as a data object, record, or list, that can be automatically parsed, stored, and executed by the processor without manual interpretation, for example a format including identifiers, timestamps, and parameters.

The term “learning item” refers to an individual element in a learning plan, such as a single task, session, topic unit, or activity specification, that can be associated with one or more educational resources.

The term “educational resource” refers to digital or non-digital content usable for learning, including but not limited to instructional documents, audiovisual materials, assessment items, interactive exercises, and course modules.

The term “learning content database” refers to a data storage system in which metadata and identifiers for educational resources are stored so that they can be searched, retrieved, and associated with learning items in a learning plan.

The term “sequence of specific learning tasks” refers to an ordered collection of learning items for a user, where each learning item is linked to one or more educational resources and includes execution parameters such as timing, duration, and content type.

The term “user terminal” refers to an information processing device operated by a user, such as a smartphone, tablet, or personal computer, that communicates with the server to send learning information and emotion information and to receive learning plans, tasks, and display data.

The term “learning execution history” refers to a set of records representing actual execution of learning tasks by a user, including at least task identifiers, start times, end times, performance metrics, and any associated emotion information.

The term “update prompt sentence” refers to a prompt sentence generated after initial deployment of a learning plan, the prompt sentence encoding updated conditions or constraints, including adjustments to learning time, difficulty level, or content type, and instructing a generative AI model to revise the learning plan.

The term “revised learning plan” refers to a learning plan output from a generative AI model in response to an update prompt sentence and reflecting modifications based on newly collected learning execution history and emotion information.

The term “indicator data” refers to numerical or symbolic values computed by the processor that quantify learning progress, performance levels, or weak domains, and that are usable to generate visual or textual representations of such states.

The term “display data” refers to data generated from indicator data and formatted for presentation on a user terminal, including chart data, graphical elements, textual summaries, and layout information.

The term “feedback content” refers to information generated for a user that evaluates learning performance and suggests improvements, including explanations, advice, and recommended actions derived from analysis or from a generative AI model.

The term “countermeasures” refers to specific actions, resources, or plan modifications recommended to address a user's weak domain or negative emotion state, such as additional practice tasks, simplified materials, or schedule adjustments.

The term “educational institution information” refers to data describing an educational organization, such as a school, course provider, or training center, including attributes such as name, fee level, curriculum outline, modality, schedule, and evaluation metrics.

The term “educational service information” refers to data describing a learning-related service, such as a course, tutoring program, subscription, or online platform offering, including attributes such as content scope, duration, cost, and access conditions.

The term “educational service database” refers to a data storage system in which educational institution information and educational service information are stored and can be queried based on user conditions, learning information, and emotion information.

The term “candidate educational services” refers to one or more educational services selected from an educational service database as potential matches for a user on the basis of learning information, emotion information, learning objectives, and usage conditions.

The term “comparative descriptions” refers to text generated by or under control of the processor that compares two or more candidate educational services by reference to attributes such as cost, curriculum, schedule, modality, and suitability for a user's learning profile.

The term “recommendation reasons” refers to explanation information indicating why particular educational services are recommended for a user, including references to the user's learning tendency, weak domain, emotion state, objectives, and constraints.

In one embodiment, a server, one or more terminals, and a communication network constitute a system for generating, updating, and presenting individualized learning plans using a generative AI model controlled by structured prompt sentences.

The server includes at least one processor, a main memory, a non-volatile storage device, a network interface, and a database system. The server executes programs implemented, for example, using an interpreted programming language such as Python and a web framework such as a generic HTTP application framework. The server manages learning information, emotion information, educational resources, and educational service information in one or more relational databases, such as a file-based relational database or a client-server relational database.

The terminal includes at least one processor, a display, an input device, a camera, a microphone, local storage, and a network interface. The terminal executes an application implemented, for example, using a cross-platform mobile framework or a general web browser. The user operates the terminal to input profile information, to perform learning tasks, and to view learning plans and feedback.

The server stores learning information in a structured format. In one embodiment, the server stores each learning record as a row in a “learning_log” table with columns including: user identifier, content identifier, subject identifier, topic identifier, start timestamp, end timestamp, score, completion flag, and device identifier. The server stores emotion information in an “emotion_log” table with columns including: user identifier, session identifier, time offset, emotion label, emotion confidence value, and sensor modality. The server stores user profile and preference information, including learning style and goals, in a “user_profile” table. The server stores educational resources in a “content” table with identifiers, topic tags, difficulty ratings, modality type (video, quiz, document), estimated duration, and metadata.

The server acquires learning information by receiving, via the network interface, HTTP requests from the terminal containing learning records encoded in a structured message format. The server validates record structure, converts timestamps to a unified time base, and stores the validated records into the learning_log table using a database access library or object-relational mapping layer. The server acquires emotion information from the terminal either as raw sensor streams or as pre-processed features. For example, the terminal may detect facial landmarks and voice intensity locally and send time-stamped feature vectors, and the server inserts these into the emotion log table.

The server analyzes integrated information by joining learning_log and emotion_log tables keyed by user and time. The server uses a data analysis library to group learning events by subject and topic, compute per-topic accuracy values, and align emotion labels to corresponding learning segments. For example, the server constructs a feature vector for each topic containing aggregated attributes such as mean score, variance of scores, mean session length, proportion of sessions with “stressed” or “anxious” emotion labels, and frequency of voluntary task abandonment. These feature vectors form an integrated representation for that topic for a given user.

The server identifies a learning tendency by computing, for each user, summary statistics across topics and content types. For example, the server computes an average session duration, distribution of used content types, and trend of scores over time using time-series aggregation. The server classifies a user as preferring visual content when the fraction of completed video resources exceeds a threshold and the improvement rate on video-based tasks is higher than on text-based tasks. This classification is represented as a categorical attribute in the user profile table.

The server identifies a weak domain by comparing per-topic accuracy to a threshold and to a user-specific baseline. For example, when accuracy in “calculus-limits” remains below 60% while overall mathematics accuracy exceeds 75%, the server flags the “calculus-limits” topic as a weak domain. In one embodiment, the server uses a machine learning library to train a classifier model over the integrated feature vectors to predict weak domain labels, where the model is, for instance, a gradient-boosted decision tree or a multilayer perceptron. The model is trained offline on historical data using a supervised loss function such as cross-entropy; during operation, the server uses the trained model for fast weakness detection without manual rule tuning, thereby improving classification accuracy and processing speed.

The server estimates an emotion state by applying an emotion analysis engine to the emotion_log entries. In one embodiment, the server uses a convolutional neural network for image features and a recurrent neural network for audio features. The convolutional neural network may include multiple convolutional layers, pooling layers, and fully connected layers trained on labeled facial expression images. The recurrent neural network may be implemented as a long short-term memory network trained on speech segments labeled with emotion categories. The server combines the outputs of these networks into an emotion probability distribution over labels such as “stressed”, “bored”, and “engaged”, and stores the dominant label with its confidence value in the emotion_log table. By performing this computation continuously, the server obtains fine-grained emotion trajectories during learning sessions.

Based on the integrated information and the identified learning tendency, weak domain, and emotion state, the server generates a prompt sentence for a generative AI model. The generative AI model is, for example, a transformer-based neural network pre-trained on large text corpora and fine-tuned for instruction following. The server constructs the prompt sentence by combining fixed template phrases with dynamic data fields retrieved from the database. The server normalizes numeric attributes such as average daily study time and time to exam, and embeds these values in human-readable form into the prompt. An example prompt sentence is:

“The user is a high school student preparing for a math exam in 45 days.

Learning style: visual.

Average study time: 35 minutes per day.

Weak topics: calculus (limits, derivatives). Strong topics: algebra.

Create a 2-week learning plan that uses visual explanations and short daily sessions. For each day, specify the main topic, type of content (video, quiz, or mixed), and estimated time.”

The server sends this prompt sentence as input to the generative AI model via an application programming interface. The generative AI model processes the tokenized prompt using a multi-layer self-attention architecture, in which each layer computes attention weights over prior tokens to generate a contextualized representation, and outputs a sequence of tokens representing a learning plan. The server receives the token sequence, decodes it to text, and converts it into a machine-readable format by parsing the text into an internal representation, such as a list of task objects with fields “day_index”, “topic”, “content_type”, and “duration_minutes”.

The server associates each learning item in this representation with concrete educational resources. For this purpose, the server queries the content table using topic tags and content_type, ranks candidate resources by difficulty and estimated duration, and chooses suitable combinations so that the sum of durations matches the duration minutes field. The server links each learning item to one or more resource identifiers and stores the resulting sequence of specific learning tasks into a learning_plan table as a structured plan for that user.

The server delivers the learning plan to the terminal by responding to a plan-retrieval request. The terminal receives a structured description and renders it as a schedule view showing tasks ordered by date, with human-readable titles, estimated times, and action buttons. When the user selects a task, the terminal requests the corresponding resource, such as a streaming video or an interactive quiz.

The terminal measures actual execution of tasks. For each task, the terminal records the start time, end time, any quiz results, and whether the user abandoned the task early. The terminal may also record intermittent emotion indicators, such as user-reported feelings via quick surveys. The terminal periodically sends these records to the server as learning execution history.

The server updates the learning plan dynamically based on the learning execution history and the emotion information. The server computes deviations between planned and actual durations, changes in per-topic scores, and correlations between long sessions and negative emotion states. Based on these computed values, the server generates an update prompt sentence that includes explicit constraints to modify the plan. An example update prompt sentence is:

“The user shows signs of stress and low motivation when studying calculus limits for more than 25 minutes.

Please revise the existing 1-week learning plan to:
(1) limit any single calculus session to 20 minutes,
(2) insert short review of already-mastered topics,
(3) include one enjoyable or easy task each day to increase confidence.”

The server sends this update prompt sentence to the generative AI model, obtains a revised learning plan, parses it, and updates the learning_plan table. Because the server encodes emotion-based constraints directly in the prompt, the generative AI model can reorganize the plan in a way that is not easily achieved by static rule-based systems, such as creatively interleaving different topics to manage cognitive load. The server then pushes the revised plan to the terminal, which refreshes the user interface.

The server further generates a prompt sentence to obtain feedback content and countermeasures. The server summarizes integrated information, learning execution history, and emotion information into a concise description and embeds it into a prompt such as:

“The learner's data is as follows:
English grammar scores improved from 60% to 75% in the last two weeks.
Speaking practice is attempted only once a week, and emotion analysis indicates anxiety during speaking exercises.

Provide encouraging feedback, concrete advice for reducing anxiety, and specific speaking practice tasks for the next week.”

The server transmits this prompt sentence to the generative AI model, receives the generated feedback, and formats it for display. The server stores the feedback in a feedback table linked to the user and the relevant time interval. The terminal retrieves the feedback and presents it in categorized form, for example as “progress”, “weak points”, and “next steps”.

In another embodiment, the server acquires educational institution information and educational service information from an educational service database. The server uses learning information, emotion information, and user-provided learning objectives and usage conditions to filter and rank services. The server may then generate a prompt sentence for the generative AI model, for example:

“The learner's goal is to reach TOEFL iBT score 90 within 6 months.

The following candidate schools are available (with attributes Name, Price, Format, Schedule, and Rating): [structured list].

Compare these options and recommend the top 3, explaining the reasons in simple language.”

The server provides structured attributes and the candidate list as part of the prompt, receives comparative descriptions and recommendation reasons from the generative AI model, and combines them with the structured list. The terminal displays the rankings and explanations. This integration of structured and unstructured processing allows the server to reuse the same generative AI infrastructure and prompt generation pipeline for both learning plan generation and service recommendation.

In terms of internal AI model processing, the server does not simply invoke a black-box service. The server configures the generative AI model with specific decoding parameters, such as maximum token length, temperature, top-k sampling, and stop conditions, to control generation length and variability. In some embodiments, the server also fine-tunes the generative AI model on domain-specific instruction-response pairs that include examples of learning plans, feedback, and recommendations, enabling better alignment between prompt sentences and output structure. During fine-tuning, the server uses a loss function such as token-level cross-entropy and updates model weights using gradient descent with parameter regularization. The server may further employ data augmentation techniques, such as paraphrasing of instructions or synthetic score histories, to increase robustness.

The described configuration improves computer technology itself for several reasons. By constructing integrated feature vectors that combine learning and emotion signals, the server reduces the need for multiple separate pipelines and enables single-pass analysis that feeds directly into prompt creation. This reduces processing latency and memory usage as compared to architectures that operate on independent data silos. The automated prompt sentence generation, based on parameterized templates and normalized values, yields consistent and machine-optimized inputs to the generative AI model, which improves determinism and reduces the number of trial-and-error queries, thereby lowering network traffic and computational load.

Moreover, by mapping free-form generative outputs to structured task objects and binding them to content identifiers, the server transforms inherently unstructured text into executable instructions for programmatic control of content delivery. This conversion allows the system to schedule tasks, pre-fetch associated resources, and cache frequently used content, which leads to improved response time and reduced bandwidth usage. The dynamic adjustment mechanism, using update prompt sentences derived from continuous telemetry, provides an iterative optimization loop that converges more quickly to effective learning plans than static rule systems, so the server can achieve better learning outcome predictions with fewer cycles of analysis and plan regeneration.

The emotion-aware adjustment is not a mere human-like decision; the server uses quantitative thresholds and machine-learned models to translate emotion signals into plan parameters such as maximum session length and content difficulty. This translation is encoded in data structures and prompt fields and executed consistently for each user, eliminating human variance and improving reproducibility. Because the neural network architectures and training processes are explicitly defined, the emotion analysis provides statistically robust labels that are more precise than ad hoc human judgment, which in turn yields more accurate plan adaptations.

In alternative embodiments, the server can replace or supplement the transformer-based generative AI model with other sequence-to-sequence models, such as encoder-decoder recurrent networks or retrieval-augmented generators. The server can also vary the neural architectures for emotion analysis, for example by using graph neural networks for facial landmark graphs or attention-based audio encoders. The data storage structure can be implemented using columnar databases to accelerate analytical queries, or distributed databases to support large-scale deployments.

In another variation, the terminal may execute part of the data processing locally, such as emotion feature extraction or initial aggregation of learning logs, and send pre-aggregated summaries to the server. This reduces network traffic and allows the server to focus on high-level analysis and prompt generation. In yet another variation, the server may adjust sampling intervals, synchronization frequencies, or cache policies based on current network conditions, further optimizing communication efficiency.

Across these embodiments, the server, the terminal, and the generative AI model cooperate through defined data structures, predetermined algorithms, and explicit prompt sentences to achieve technical effects that go beyond automating human teaching tasks. The system introduces non-conventional processing flows—integrated feature construction, automatic prompt orchestration, structured mapping of generative outputs, and emotion-constrained plan revision—that improve computational efficiency, resource utilization, and prediction accuracy on computer hardware, thereby providing a specific and concrete implementation of the claimed invention.

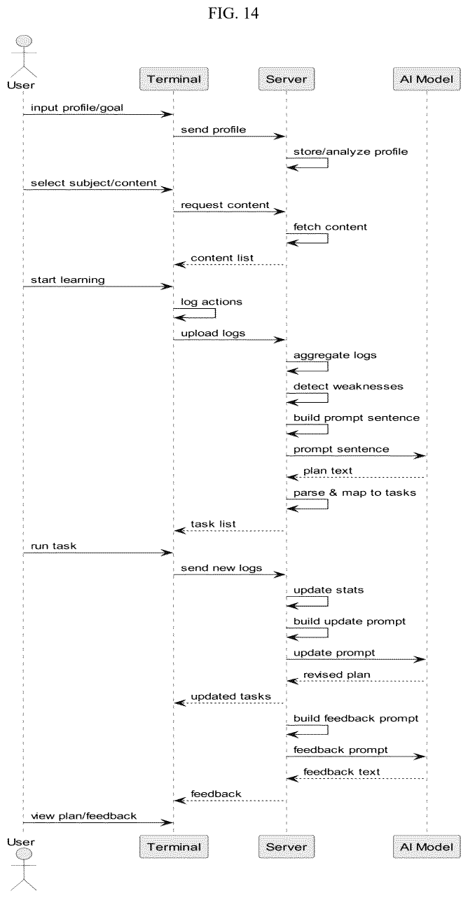

The following describes the processing flow using FIG. 14.

### Step 1:

The user operates the terminal to input profile information such as age group, target examination, preferred subjects, learning style, and available study time.

The terminal receives this input as form fields (input), validates required fields and data types, converts the fields into a structured record, and outputs a profile object.

The terminal sends the profile object to the server as a message via a network request.

### Step 2:

The server receives the profile object from the terminal (input), parses the fields, and normalizes values such as time units and subject identifiers.

The server performs data processing by mapping free-text entries to controlled vocabulary codes and by assigning a unique user identifier, then outputs a normalized profile record.

The server stores the normalized profile record into a user profile table in a database.

### Step 3:

The user selects a learning subject or topic, such as mathematics or English grammar, from a list displayed on the terminal.

The terminal converts this selection into a subject request (input), adds the user identifier, and outputs a subject selection message.

The terminal sends the subject selection message to the server as a request for available learning content.

### Step 4:

The server receives the subject selection message (input), queries a content table for educational resources tagged with the requested subject and compatible difficulty, and performs a filtering computation based on user profile attributes.

The server aggregates the matching records into a content list, including resource identifiers, types, and estimated durations, and outputs a content list object.

The server returns the content list object to the terminal in a structured format.

### Step 5:

The terminal receives the content list object from the server (input), converts it into visual elements such as cards or list items, and outputs a rendered content selection screen.

The user views this screen and selects a specific resource, such as a video or quiz, to start a learning session.

### Step 6:

The terminal receives the user's resource selection (input), records the current timestamp as a session start time, and initializes a local session record containing user identifier, content identifier, and start time.

The terminal outputs a session state object and begins presenting the resource, for example by playing a video or displaying quiz questions.

### Step 7:

The user interacts with the resource by watching, scrolling, and answering questions.

The terminal captures these interactions (input) and updates the session state by recording events such as question responses and interim pause times.

The terminal computes partial statistics, such as number of questions answered and interim elapsed time, and stores these statistics in local storage as an evolving session log.

### Step 8:

The user finishes the learning session by closing the resource or submitting the last answer.

The terminal detects session completion (input), records the end timestamp, and calculates the total session duration and, if applicable, a score.

The terminal outputs a finalized session record containing user identifier, content identifier, start time, end time, duration, score, and completion status, and stores this record locally.

### Step 9:

The terminal periodically checks for unsynchronized session records in local storage (input), batches these records into an upload bundle, and outputs a learning log bundle.

The terminal sends the learning log bundle to the server as a learning execution history upload request.

### Step 10:

The server receives the learning log bundle (input), validates record formats and timestamps, and performs a normalization operation such as converting local time to server time and mapping content identifiers to internal codes.

The server inserts the validated records into a learning log table and, as output, generates an acknowledgment message containing accepted record identifiers.

The server returns the acknowledgment message to the terminal.

### Step 11:

The server periodically retrieves recent learning log records and associated profile data from the database (input) and uses a data processing library to group records by user, subject, and topic.

The server performs data aggregation operations, including computing average score per topic, total study time per subject, and session frequency, and outputs a set of aggregated learning statistics.

The server stores these aggregated statistics as summary entries in a learning summary table.

### Step 12:

The server accesses emotion log records for the same users and time intervals (input) and joins these records with learning logs based on user identifier and session time range.

The server computes integrated feature vectors by combining performance metrics (such as average score) and emotion metrics (such as proportion of “stressed” states), and outputs a collection of integrated feature vectors per topic per user.

The server stores these integrated feature vectors in a data structure usable for weakness detection and prompt generation.

### Step 13:

The server takes the integrated feature vectors as input and executes a weakness detection algorithm, such as a trained classifier, that compares topic-level performance to learned decision boundaries.

The server performs mathematical operations on the feature space, including normalization, distance calculations, or classification scores, and outputs a list of weak domains for each user.

The server writes the identified weak domains into the learning summary table as structured weakness entries.

### Step 14:

The server reads, for a given user, the profile record, the aggregated learning statistics, the weak domains, and recent emotion states (input) and combines these into a high-level textual summary.

The server uses a template-based generation routine to insert numeric values and category labels into sentence slots, produces a human-readable prompt text, and outputs a prompt sentence for a generative AI model.

An example prompt sentence is:

“The user is a high school student preparing for a math exam in 45 days.

Learning style: visual.

Average study time: 35 minutes per day.

Weak topics: calculus (limits, derivatives). Strong topics: algebra.

Create a 2-week learning plan that uses visual explanations and short daily sessions. For each day, specify the main topic, type of content (video, quiz, or mixed), and estimated time.”

### Step 15:

The server sends the prompt sentence to a generative AI model through an interface (input) and specifies generation parameters such as maximum output length and sampling temperature.

The generative AI model processes the prompt through its neural network layers and returns a textual learning plan as output.

The server receives this textual learning plan and outputs it as a raw generative response to a downstream parsing module.

### Step 16:

The server takes the raw generative response (input) and executes a parsing procedure that detects day markers, topic descriptions, content types, and durations.

The server performs text segmentation and pattern matching to extract structured attributes, and outputs a structured learning plan represented as a list of learning items with fields such as “day_index”, “topic”, “content_type”, and “duration_minutes”.

The server validates that all required fields are present and that durations are within permissible limits.

### Step 17:

The server takes each learning item as input and queries the content table for educational resources that match the specified topic and content_type.

The server computes ranking scores based on difficulty, estimated duration, and prior effectiveness statistics, selects an appropriate resource for each learning item, and outputs a resource-linked task list.

The server stores this resource-linked task list in a learning plan table as the current plan for the user.

### Step 18:

The terminal sends a request for the current learning plan for a particular user (input) to the server.

The server retrieves the corresponding resource-linked task list from the learning plan table, filters items by current date, and outputs a subset representing pending tasks.

The terminal receives this subset, converts it into a display list showing topics, durations, and start buttons, and renders it on the screen.

### Step 19:

The user selects one of the displayed tasks and starts a new session on the terminal.

The terminal combines the task identifier and the associated resource identifier (input), initializes a new session state, and outputs a session object with references to both the plan item and the content.

The terminal presents the resource as in the earlier learning session and repeats interaction logging as further input for the system.

### Step 20:

The terminal, during the session, uses the camera and microphone to capture user image and voice signals (input), and extracts basic features such as facial landmark coordinates and short-term audio energy.

The terminal encrypts and packages these features with timestamps and session identifiers, and outputs an emotion feature bundle.

The terminal sends the emotion feature bundle to the server as part of the ongoing session telemetry.

### Step 21:

The server receives the emotion feature bundle (input) and feeds the features into an emotion recognition model such as a convolutional-recurrent network.

The server performs numerical computations including matrix multiplications, non-linear activations, and softmax normalization to obtain probabilities for each emotion label, and outputs emotion state labels with confidence values.

The server stores these labels in the emotion log table linked to the current session.

### Step 22:

The server periodically reads updated learning execution history and emotion state labels for a user (input) and computes deviations between planned and actual durations, changes in score per topic, and correlations between long sessions and negative emotions.

The server executes comparison and correlation operations on the data arrays, and outputs adjustment parameters such as reduced maximum duration for a weak domain, or increased number of review tasks.

The server uses these adjustment parameters to construct an update prompt sentence describing constraints for revising the plan.

### Step 23:

The server generates the update prompt sentence using a template that incorporates the adjustment parameters (input) and produces a human-readable instruction for plan revision.

An example update prompt sentence is:

“The user shows signs of stress and low motivation when studying calculus limits for more than 25 minutes.

Please revise the existing 1-week learning plan to:
(1) limit any single calculus session to 20 minutes,
(2) insert short review of already-mastered topics,
(3) include one enjoyable or easy task each day to increase confidence.”

The server outputs this update prompt sentence and sends it to the generative AI model.

### Step 24:

The generative AI model receives the update prompt sentence (input), generates a revised learning plan text under the specified constraints, and returns the text as output.

The server receives the revised plan, parses it again to structured form using the parsing procedure, and outputs a revised resource-linked task list.

The server overwrites or augments the existing learning plan in the learning plan table with this revised task list.

### Step 25:

The server sends a notification to the terminal that an updated plan is available (input), including a condensed change summary.

The terminal retrieves the revised task list from the server, compares it with the previous tasks, and outputs a refreshed schedule view indicating newly added or changed items.

The user sees the updated plan and may choose tasks according to the revised schedule.

### Step 26:

The server, to generate feedback content, takes integrated information, weak domains, and recent emotion summaries as input and creates a condensed status description.

The server embeds this status description into a feedback-oriented prompt sentence, such as:

“The learner's data is as follows:
English grammar scores improved from 60% to 75% in the last two weeks.
Speaking practice is attempted only once a week, and emotion analysis indicates anxiety during speaking exercises.

Provide encouraging feedback, concrete advice for reducing anxiety, and specific speaking practice tasks for the next week.”

The server outputs this prompt sentence and sends it to the generative AI model.

### Step 27:

The generative AI model receives the feedback prompt sentence (input), generates textual feedback and suggested actions, and returns this text as output.

The server receives the generated feedback text, segments it into sections such as “progress”, “issues”, and “recommendations”, and outputs a structured feedback object.

The server stores the structured feedback object in a feedback table and makes it available for retrieval.

### Step 28:

The terminal requests the latest feedback for the user (input) from the server and receives the structured feedback object.

The terminal converts this object into visual elements such as headings and bullet points, and outputs a feedback screen that the user can scroll and read.

The user may optionally respond with comments or questions, which the terminal records and forwards as new input to the server for future analysis and prompt generation.

### Step 29:

The user accesses an educational service recommendation screen on the terminal and enters learning objectives, budget, and usage constraints as input.

The terminal packages this information into a recommendation request message with the user identifier and outputs the message to the server.

The server receives the recommendation request, queries an educational service database based on these conditions and the user's learning profile, and outputs a set of candidate educational services.

### Step 30:

The server takes the candidate services and the user context as input and constructs a recommendation prompt sentence for the generative AI model.

An example prompt sentence is:

“The learner's goal is to reach TOEFL IBT score 90 within 6 months.

The following candidate schools are available (with attributes Name, Price, Format, Schedule, and Rating): [structured list].

Compare these options and recommend the top 3, explaining the reasons in simple language.”

The server sends this prompt sentence and the structured list to the generative AI model and outputs the model's comparative explanation as a recommendation description.

### Step 31:

The server returns the candidate services and the recommendation description (input) to the terminal.

The terminal merges the structured attributes with the textual explanations, generates a comparison table with accompanying narrative, and outputs a recommendation view.

The user inspects this view and may select a service, which becomes further input to subsequent purchase or enrollment processes.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

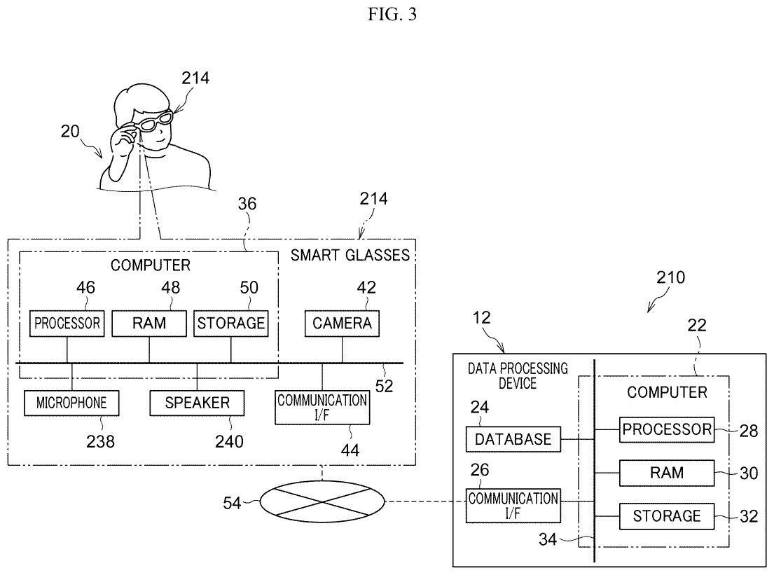

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

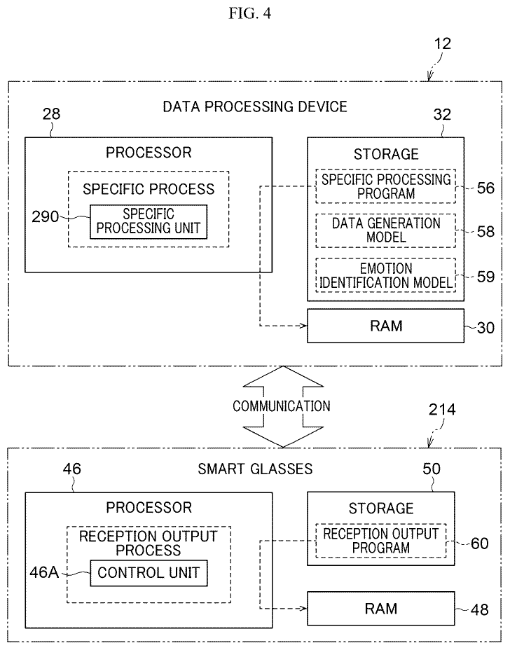

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

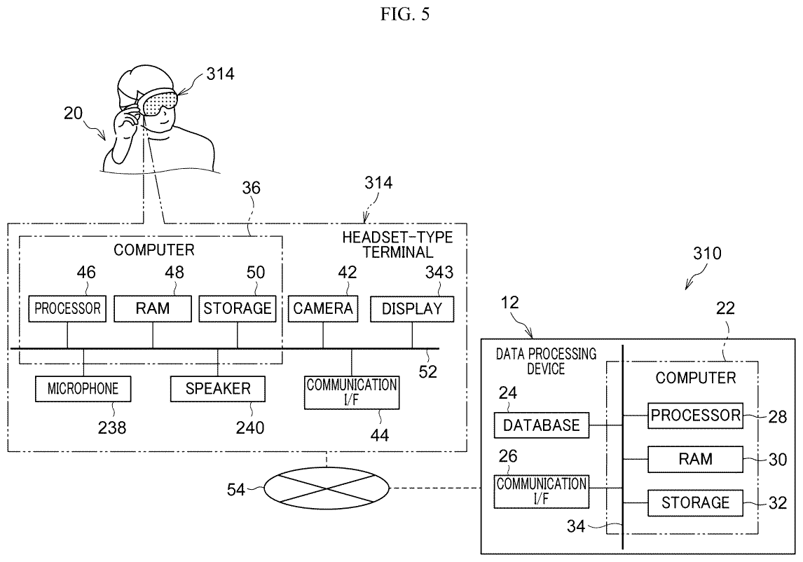

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

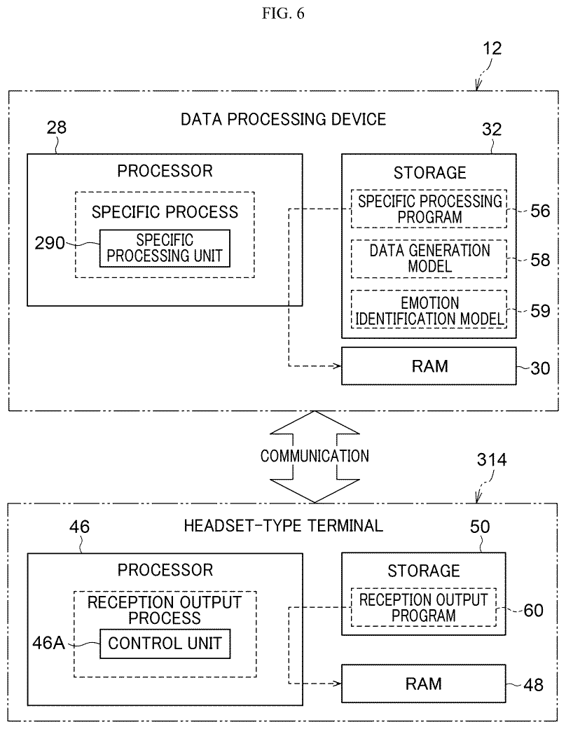

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

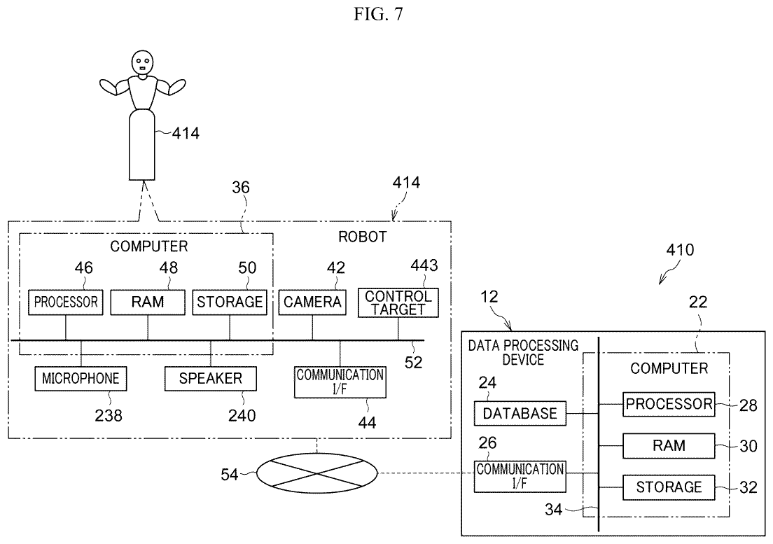

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

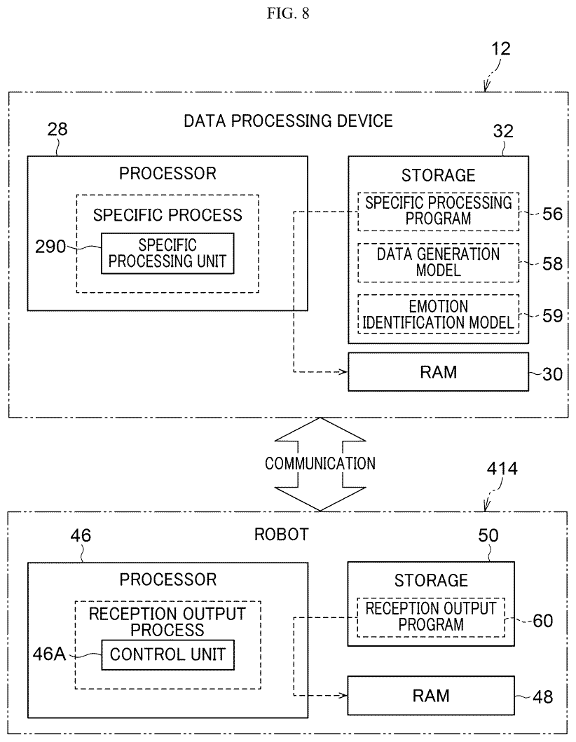

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

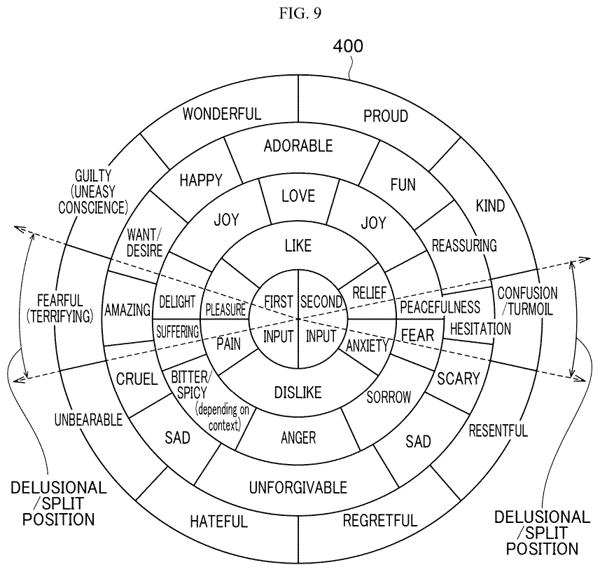

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

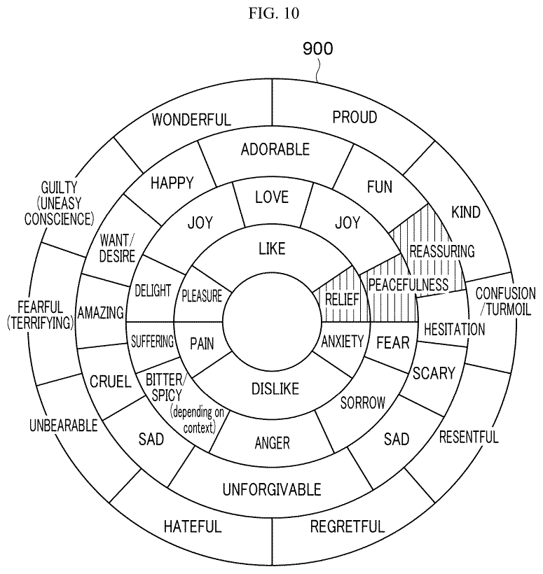

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
acquire user characteristic information and learning objective information from a terminal, normalize the acquired information into a generic data format, and store the normalized information in the storage device,
analyze, by using a generic data processing program, the user characteristic information and the learning objective information stored in the storage device together with past learning data and learning progress data, derive learning attributes including at least a learning style, a learning ability, a learning period, and an available learning time, and generate a prompt sentence in which the learning attributes and analysis results are embedded, the prompt sentence being input to a generative AI model so as to instruct the generative AI model to generate an individualized learning plan,
parse learning plan text obtained from the generative AI model, convert the learning plan text into structured data including learning tasks, learning topics, and teaching material types on a per-day basis or a per-session basis, and select teaching materials corresponding to the user learning style based on the structured data and provide the teaching materials and the learning plan to the terminal,
acquire learning progress data including execution status of the learning tasks, answer results, and learning time from the terminal, store the learning progress data in the storage device, analyze the learning progress data to extract weak fields and delay states in progress, and generate an update prompt sentence including the extracted results and input the update prompt sentence to the generative AI model so as to instruct the generative AI model to update the learning plan and generate feedback, and
acquire candidate educational institution information from an information storage device storing educational institution information, based on user conditions and the analysis results, generate a prompt sentence including the candidate educational institution information and the learning attributes of the user, and input the prompt sentence to the generative AI model so as to cause the generative AI model to generate a recommendation of an optimal educational institution and a learning plan adjustment proposal consistent with enrollment conditions of the optimal educational institution, and provide a result thereof to the terminal.

### (Supplementary 2)

The system according to supplementary 1,
wherein the processor is configured to, in generating the prompt sentence, add constraint conditions including an output format, a character count constraint, and a ratio of teaching material types to the prompt sentence so as to control an output format and contents of the learning plan and the feedback generated by the generative AI model.

### (Supplementary 3)

The system according to supplementary 1,
wherein the processor is configured to parse the learning plan text obtained from the generative AI model, generate learning task data to which difficulty attributes and progress evaluation indices are added based on date information, topic information, task information, and teaching material type information, store the learning task data in the storage device, and convert the learning task data into display data that can be presented by the terminal in a schedule display format or a list display format.

### Application Example 1

### (Supplementary 1)

A system comprising a processor,
wherein the processor is configured to
acquire learner characteristic information and learning ability information from a terminal, and store the learner characteristic information and the learning ability information as learner profile information,
generate, based on the learner profile information and past learning data of the learner, a prompt sentence expressed in natural language as input data for a generative AI model,
execute numerical computation processing using the generative AI model based on the prompt sentence, and generate personalized learning plan information for the learner,
analyze the generated learning plan information and convert the learning plan information into structured data including schedule information, learning material information, and learning method information,
select, based on the learning material information included in the structured data, learning materials associated with the learner characteristic information and the learning ability information, and present the learning materials and the learning plan information to the learner via the terminal, and
store learning progress information and feedback information acquired from the terminal in association with the learner profile information, regenerate the prompt sentence based on updated profile information including the learning progress information and the feedback information, and repeatedly execute regeneration processing of the learning plan information by the generative AI model.

### (Supplementary 2)

The system according to supplementary 1,
wherein the processor is configured to
analyze the learning progress information and the feedback information to identify weakness areas and achievement levels of the learner, generate a prompt sentence including a description explicitly indicating the weakness areas and the achievement levels, and instruct the generative AI model to generate learning plan information including reinforcement learning tasks corresponding to the weakness areas and specific feedback content.

### (Supplementary 3)

The system according to supplementary 1,
wherein the processor is configured to
acquire, from a storage device, institution information including information on educational institutions, include, in the prompt sentence, condition information regarding types of institutions, educational content, difficulty levels, and admission requirements based on the learner profile information and the learning progress information, instruct the generative AI model to generate recommendation information including candidate institutions consistent with the learning plan information and the condition information and reasons for selection of the candidate institutions, and select optimal institutions based on the generated recommendation information and present the optimal institutions to the learner via the terminal.

### Example 2

### (Supplementary 1)

A system comprising a processor, a storage device, and a communication interface, wherein the processor is configured to
acquire learning history information, transmitted from an information terminal device used by a learner, the learning history information including learning activity information of the learner, and store the learning history information in the storage device,
analyze, by using statistical processing and numerical computation, the learning history information and learner attribute information stored in the storage device to calculate learning time information, evaluation information, progress indices, and weakness indices for the learner,
generate, by using visualization processing, progress display data by converting calculation results of the learning time information, the evaluation information, the progress indices, and the weakness indices into graphical information representing a learning progress state of the learner on a time axis and per learning domain, and output the progress display data to the information terminal device via the communication interface,
generate a prompt sentence to instruct a generative AI model to generate learning plan information based on the learning history information, the learner attribute information, and the calculation results, input the prompt sentence and at least part of the learning history information to the generative AI model via the communication interface, and acquire the learning plan information output from the generative AI model,
convert the learning plan information into structured information, generate learning plan data including learning time allocation information and learning activity content information for each learning domain based on the learning plan information and the calculation results, select educational content information corresponding to the learning plan data from the storage device, and provide the educational content information to the information terminal device via the communication interface, and
acquire, from the information terminal device via the communication interface, evaluation information and constraint condition information relating to the learning plan data, associate the evaluation information and the constraint condition information with the learning history information in the storage device, generate an update prompt sentence reflecting the evaluation information and the constraint condition information, input the update prompt sentence to the generative AI model, and dynamically update the learning plan data based on updated learning plan information output from the generative AI model.

### (Supplementary 2)

The system according to supplementary 1,
wherein the processor is configured to
generate, based on the learning history information and the calculation results, score transition information, learning time transition information, and achievement level information for each learning domain, generate a prompt sentence to instruct the generative AI model to generate weakness region information, feedback information, and improvement strategy information for the learner, acquire the weakness region information, the feedback information, and the improvement strategy information from the generative AI model, and reflect the weakness region information, the feedback information, and the improvement strategy information in selection of the educational content information and in updating of the learning plan data.

### (Supplementary 3)

The system according to supplementary 1,
wherein the processor is configured to
acquire organization information relating to an educational organization selected by the learner from an organization information storage device, analyze the organization information based on the learner attribute information and target condition information included in the learning plan data, generate a prompt sentence to instruct the generative AI model to generate recommendation information of one or more educational organization candidates satisfying the target condition information and to generate a learning plan adjustment proposal corresponding to the educational organization candidates, acquire the recommendation information and the learning plan adjustment proposal from the generative AI model, and provide the recommendation information and the learning plan adjustment proposal to the information terminal device via the communication interface.

### Application Example 2

### (Supplementary 1)

A system comprising a processor,
wherein the processor is configured to
acquire and store learning information and emotion information relating to a user,
analyze integrated information including the learning information and the emotion
information to identify, for each user, a learning tendency, a weak domain, and an emotion state,
generate a prompt sentence for a generative AI model, the prompt sentence instructing the generative AI model to generate a learning plan based on the integrated information and the identified learning tendency, weak domain, and emotion state,
convert a learning plan obtained from the generative AI model into a machine-readable format, and, by associating individual learning items in the learning plan with educational resources in a learning content database, construct a sequence of specific learning tasks for each user,
deliver the constructed sequence of learning tasks to a user terminal, and, by continuously collecting a learning execution history transmitted from the user terminal, dynamically update the learning plan,
generate, in updating the learning plan, an update prompt sentence including conditions for adjusting at least one of learning time, difficulty level, and content type on the basis of the learning execution history and the emotion information, and input the update prompt sentence to the generative AI model to obtain a revised learning plan, and
generate indicator data and display data for visualizing learning progress and the weak domain based on the analysis result, and provide the display data to the user terminal.

### (Supplementary 2)

The system according to supplementary 1,
wherein the processor is configured to
generate, based on the integrated information and the learning execution history, a prompt sentence that instructs the generative AI model to extract the weak domain and to generate feedback content and countermeasures, and provide feedback information obtained from the generative AI model to the user terminal.

### (Supplementary 3)

The system according to supplementary 1,
wherein the processor is configured to
acquire educational institution information and educational service information from an educational service database on the basis of the learning information, the emotion information, and learning objectives and usage conditions input by the user, analyze the acquired information to extract candidate educational services, generate, when necessary, a prompt sentence that instructs the generative AI model to generate comparative descriptions and recommendation reasons, and present the candidate educational services together with explanation information obtained from the generative AI model to the user terminal.

What is claimed is:

1. A system comprising:
circuitry configured to:
acquire, via a communication interface coupled to a packet-switched network, user characteristic data and historical activity data encoded as packet data from a terminal device, normalize the acquired data into a standardized data format, and store the normalized data as multidimensional feature tensors in a storage device;
analyze, by executing a data processing pipeline, the multidimensional feature tensors together with progress data tensors to derive attribute parameter vectors including at least a style parameter, an ability parameter, a temporal parameter, and an availability parameter using a trained classification model;
generate an instruction sequence in which the attribute parameter vectors and analysis result data are embedded as structured token subsequences, and input the instruction sequence into a generative neural network model comprising a transformer-based architecture with multi-layer self-attention sublayers and feed-forward sublayers to cause the generative neural network model to generate structured output data;
parse an output token sequence obtained from the generative neural network model to convert the output token sequence into structured data records including task identifiers, topic identifiers, and content type identifiers organized on a per-session basis, and select content items corresponding to the attribute parameter vectors based on the structured data records;
acquire, from the terminal device via the communication interface, updated progress data encoded as packet data including execution status information and result data, store the updated progress data in the storage device, analyze the updated progress data to extract deficiency indicator vectors and delay state data, and generate an updated instruction sequence including the deficiency indicator vectors and re-input the updated instruction sequence into the generative neural network model to generate revised structured output data and remediation data; and
transmit the structured output data, the selected content items, and the remediation data to the terminal device via the communication interface.

2. The system according to claim 1, wherein the circuitry is further configured to:
analyze the user characteristic data to determine the style parameter by classifying the user into one of a plurality of predefined interaction mode categories, and determine the ability parameter by computing a proficiency score from the historical activity data using statistical aggregation of result data across a plurality of activity domains.

3. The system according to claim 2, wherein the circuitry is further configured to:
derive the temporal parameter by extracting a target completion period from the user characteristic data, and derive the availability parameter by computing an available time allocation per unit period from schedule constraint data included in the user characteristic data.

4. The system according to claim 3, wherein the circuitry is further configured to:
generate the instruction sequence by concatenating a system instruction portion specifying an output format and content constraints, a context portion including the attribute parameter vectors and analysis result data, and a constraint portion specifying at least an output format constraint, a length constraint, and a content type ratio constraint, so as to control the structured output data generated by the generative neural network model.

5. The system according to claim 4, wherein the circuitry is further configured to:
parse the output token sequence by detecting delimiter markers in the output token sequence, and generate structured data records to which difficulty attributes and progress evaluation indices are added based on date information, topic information, task information, and content type information extracted from the output token sequence, and store the structured data records in the storage device.

6. The system according to claim 1, wherein:
the generative neural network model comprises a multi-layer self-attention architecture with multi-head attention sublayers and feed-forward sublayers, and the circuitry is configured to control decoding of the generative neural network model using a beam search algorithm with a temperature parameter and a maximum output length parameter.

7. The system according to claim 6, wherein the circuitry is further configured to:
select the content items by matching the content type identifiers in the structured data records against content metadata stored in the storage device, and filter the content items based on a difficulty level associated with the ability parameter and the style parameter of the user.

8. The system according to claim 7, wherein the circuitry is further configured to:
convert the structured data records into display data formatted for presentation by the terminal device in at least one of a schedule display format or a list display format, and transmit the display data to the terminal device via the communication interface.

9. The system according to claim 1, wherein the circuitry is further configured to:
analyze the updated progress data by computing score transition information, time allocation transition information, and achievement level information for each activity domain, and extract the deficiency indicator vectors by identifying activity domains in which the achievement level information falls below a threshold value.

10. The system according to claim 9, wherein the circuitry is further configured to:
generate the updated instruction sequence by including a description explicitly indicating the deficiency indicator vectors and corresponding achievement levels, and instruct the generative neural network model to generate the remediation data including reinforcement task information corresponding to the deficiency indicator vectors and specific remediation content.

11. The system according to claim 10, wherein the circuitry is further configured to:
reflect the deficiency indicator vectors and the remediation data in subsequent selection of the content items by adjusting content type ratios and difficulty levels in the structured data records to increase allocation of content items addressing the deficiency indicator vectors.

12. The system according to claim 1, wherein the circuitry is further configured to:
acquire candidate entity information from an information storage device storing entity records, the entity records including at least identification data, offered category data, fee data, and condition data for each entity.

13. The system according to claim 12, wherein the circuitry is further configured to:
generate a recommendation instruction sequence including the candidate entity information and the attribute parameter vectors, input the recommendation instruction sequence into the generative neural network model, and acquire from the generative neural network model recommendation data including ranked entity identifiers, selection rationale data, and a task schedule adjustment proposal consistent with conditions of a recommended entity.

14. The system according to claim 1, wherein the circuitry is further configured to:
acquire, from the terminal device, emotion data associated with the user, analyze the emotion data together with the progress data tensors to determine an emotion state, and incorporate the emotion state into the instruction sequence so as to adjust at least one of a difficulty level, a content type, or a session duration in the structured output data generated by the generative neural network model.

15. The system according to claim 14, wherein the circuitry is further configured to:
generate indicator data by computing progress metrics and deficiency metrics from the updated progress data, convert the indicator data into graphical rendering parameters representing a progress state of the user on a time axis and per activity domain, and transmit the graphical rendering parameters to the terminal device for visualization.

16. The system according to claim 1, wherein the circuitry is further configured to:
continuously collect execution history data transmitted from the terminal device, dynamically update the structured output data by generating successive updated instruction sequences at predetermined intervals based on latest execution history data, and re-input each successive updated instruction sequence into the generative neural network model to obtain successively revised structured output data.

17. The system according to claim 16, wherein:
the historical activity data comprises past learning data of a learner, the structured output data comprises an individualized learning plan, the content items comprise learning materials selected based on the learning plan, the deficiency indicator vectors comprise identified weaknesses in learning performance, the remediation data comprises countermeasures for addressing the weaknesses, and the candidate entity information comprises information regarding educational institutions, the circuitry being configured to recommend an optimal educational institution based on conditions of the learner including learning goals, budget, and preferred learning style.

18. A system comprising:
circuitry configured to:
acquire, via a communication interface coupled to a packet-switched network, activity history data and attribute data from a terminal device, and store the activity history data and the attribute data in a storage device;
analyze the activity history data by statistical processing and numerical computation to calculate time allocation data, evaluation data, progress indices, and deficiency indices for each activity domain;
generate progress display data by converting the time allocation data, the evaluation data, the progress indices, and the deficiency indices into graphical information representing a progress state on a time axis and per activity domain, and transmit the progress display data to the terminal device via the communication interface;
generate an instruction sequence based on the activity history data, the attribute data, and the calculated indices, input the instruction sequence into a generative neural network model comprising a transformer-based architecture, and acquire structured output data from the generative neural network model;
convert the structured output data into structured information including time allocation information and activity content information for each domain, select content items corresponding to the structured information from the storage device, and transmit the content items to the terminal device via the communication interface; and
acquire evaluation data and constraint condition data from the terminal device, generate an updated instruction sequence reflecting the evaluation data and the constraint condition data, and re-input the updated instruction sequence into the generative neural network model to dynamically update the structured output data.

19. The system according to claim 18, wherein the circuitry is further configured to:
generate, based on the activity history data and the calculated indices, a deficiency analysis instruction sequence that instructs the generative neural network model to extract deficiency domain information, remediation content, and improvement strategy information, and reflect the deficiency domain information and the improvement strategy information in selection of the content items and in updating of the structured output data.

20. A method performed by circuitry of a system, the method comprising:
acquiring, via a communication interface coupled to a packet-switched network, user characteristic data and historical activity data encoded as packet data from a terminal device, normalizing the acquired data into a standardized data format, and storing the normalized data as multidimensional feature tensors in a storage device;
analyzing, by executing a data processing pipeline, the multidimensional feature tensors together with progress data tensors to derive attribute parameter vectors including at least a style parameter, an ability parameter, a temporal parameter, and an availability parameter using a trained classification model;
generating an instruction sequence in which the attribute parameter vectors and analysis result data are embedded as structured token subsequences, and inputting the instruction sequence into a generative neural network model comprising a transformer-based architecture with multi-layer self-attention sublayers and feed-forward sublayers to cause the generative neural network model to generate structured output data;
parsing an output token sequence obtained from the generative neural network model to convert the output token sequence into structured data records including task identifiers, topic identifiers, and content type identifiers organized on a per-session basis, and selecting content items corresponding to the attribute parameter vectors based on the structured data records;
acquiring, from the terminal device via the communication interface, updated progress data encoded as packet data including execution status information and result data, storing the updated progress data in the storage device, analyzing the updated progress data to extract deficiency indicator vectors and delay state data, and generating an updated instruction sequence including the deficiency indicator vectors and re-inputting the updated instruction sequence into the generative neural network model to generate revised structured output data and remediation data; and
transmitting the structured output data, the selected content items, and the remediation data to the terminal device via the communication interface.
